(19) United States
(12) Patent Application Publication
(10) Pub. No.: US 2023/0140057 A1
(43) Pub. Date: May 4, 2023

(54) CONVERSATIONAL USER EXPERIENCE FOR MULTIMODAL TRAVEL SYSTEM

(71) Applicant: SONY GROUP CORPORATION, TOKYO (JP)

(72) Inventors: SANTHOSH SAMARTHYAM, BANGALORE (IN); MADHVESH SULIBHAVI, BANGALORE (IN)

(21) Appl. No.: 17/515,839

(22) Filed: Nov. 1, 2021

(51) Int. Cl. G06Q 10/02; G06F 40/20; H04L 12/58; G06T 19/00; G06Q 50/14

(52) U.S. Cl. CPC G06Q 10/025; G06F 40/20; H04L 51/046; G06T 19/006; G06Q 50/14

(57) ABSTRACT

A system and method to provide a conversational user experience for a multimodal travel system is provided. The system controls an electronic device associated with a user to render a User Interface (UI). Through the UI, one or more messages that includes a natural language input from the user are acquired. The system also acquires user data. The acquired one or more messages are processed using one or more natural language processing (NLP) models to determine contextual information which indicates an intent of the user to travel to a location and a schedule associated with the travel. Based on the contextual information and the user data, the system generates a travel plan. The system triggers a mobility-as-a-service (MaaS) network to generate booking details for a trip specified in the travel plan and controls the electronic device to display the generated booking details onto the UI.

### CROSS-REFERENCE TO RELATED APPLICATIONS/INCORPORATION BY REFERENCE

None.

### FIELD

Various embodiments of the disclosure relate to travel technology and trip planning services. More specifically, various embodiments of the disclosure relate to a system and method to provide a conversational user experience for a multimodal travel system.

### BACKGROUND

Advancements in travel technology have provided users with various services to plan, book, and pay for trips. For example, Mobility-as-a-Service (MaaS) enables various transport service providers to provide travel-related services to users through a common platform, such as a common mobile application. Typically, planning a trip may require booking of multiple transport services, such as flights, cabs, train, and so forth. The trip planning may further require booking of hotels and activities, such as sightseeing, trying local food, or attending events. Conventionally, a group planning a trip needs to communicate with each other to plan shared activities and to agree upon a travel plan. Members of such a group may typically use multiple platforms or services communicate with each other, curate travel plans, make travel decisions, plan activities in the travel plans, and decide other details. For example, users may use a messaging application to create a travel group and to discuss travel plans. Such users may further use a travel website and a cab booking application to book flights and hotels and a cab, respectively. Usage of different platforms to discuss, curate, plan, or book trips may be a time consuming activity and may lead to a weaker collaboration among the users. Additionally, it may be cumbersome for users to manage and track payments for different parts of the travel plan across different platforms.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for conversational user experience for multimodal travel system is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary network environment for conversational user experience for multimodal travel system, in accordance with an embodiment of the disclosure.

FIG. 2 is an exemplary sequence diagram that depicts conversational user experience for multimodal travel system, in accordance with an embodiment of the disclosure.

FIGS. 3A and 3B are diagrams that collectively illustrate generation of booking details and render the booking details on a user interface, in accordance with an embodiment of the disclosure.

FIG. 4A is a diagram that depicts an exemplary user interface corresponding to a home screen of a networking application, in accordance with an embodiment of the disclosure.

FIG. 4B is a diagram that depicts an exemplary user interface corresponding to a chat screen of a networking application, in accordance with an embodiment of the disclosure.

FIG. 4C is a diagram that depicts an exemplary chat user interface of a networking application, in accordance with an embodiment of the disclosure.

FIG. 4D is a diagram that depicts an exemplary user interface that displays booking details, in accordance with an embodiment of the disclosure.

FIG. 4E is a diagram that depicts an exemplary user interface that corresponds to a live map user interface, in accordance with an embodiment of the disclosure.

FIG. 4F is a diagram that depicts a generated augmented reality (AR) element, in accordance with an embodiment of the disclosure.

FIG. 4G is a diagram that depicts a plurality of clickable UI elements overlaid on a live map user interface, in accordance with an embodiment of the disclosure.

FIG. 4H is a diagram that depicts an exemplary custom map based user interface, in accordance with an embodiment of the disclosure.

FIG. 4I is a diagram that depicts one or more task widgets, in accordance with an embodiment of the disclosure.

FIG. 4J is a diagram that depicts an exemplary visual planner user interface, in accordance with an embodiment of the disclosure.

FIG. 5 is a diagram of an exemplary software-level architecture of the network environment of FIG. 1, in accordance with an embodiment of the disclosure.

FIG. 6 is a diagram that illustrates an exemplary architecture of an augmented reality (AR)-enabled conversational user experience for a multimodal travel system, in accordance with an embodiment of the disclosure.

FIG. 7 illustrates a flowchart of an exemplary method of generation of a travel plan based on a set of points of interest, in accordance with an embodiment of the disclosure.

FIGS. 8A-8C are diagrams that collectively illustrate exemplary UI elements, in accordance with an embodiment of the disclosure.

FIG. 9 is an exemplary block diagram of a system for conversational user experience for multimodal travel system, in accordance with an embodiment of the disclosure.

FIG. 10 illustrates an exemplary flowchart of a method for conversational user experience for multimodal travel system, in accordance with an embodiment of the disclosure.

### DETAILED DESCRIPTION

The following described implementations may be found in the disclosed system and method to provide a conversational user experience for a multimodal travel system. Exemplary aspects of the disclosure may provide a system that may be communicatively coupled to a Mobility-as-a-Service (MaaS) network associated with a group of transportation providers. The transportation providers may include, for example, public transport service providers, cab aggregators, private transportation service providers such as bus transport providers, car rentals, shared transportation service providers, and the like. The MaaS network may include a publish-subscribe model and a distributed ledger database. The publish-subscribe model may include a plurality of publisher nodes, a broker node, and a plurality of subscriber nodes. The distributed ledger database may include a plurality of MaaS databases.

At any time-instant, the system may control an electronic device associated with a first user to render a first User Interface (UI). The electronic device may be, for example, a smartphone of the first user and the first UI may be rendered on a display screen of the electronic device (such as the smartphone). In an embodiment, the first UI may be a chat UI (for example, a UI of a messaging application). Through the first UI, the system may acquire one or more messages that may include a natural language input from the first user. For example, the natural language input may correspond to a voice-based conversation, a video-based conversation, or a text-based conversation between the first user and one or more recipients of the one or more messages. In an exemplary scenario, the first UI may be utilized by the first user to communicate with other users on the messaging application.

The system may process the acquired one or more messages using one or more natural language processing (NLP) models to determine contextual information. The contextual information may indicate an intent of the first user to travel to a first location and a schedule associated with the travel. For example, the contextual information may include a name of the first location and preferred date of visit to the first location. Further, the system may acquire user data associated with the first user. Examples of the acquired user data may include, but are not limited to, personal information (such as a name of the first user, a location of the first user), a travel history of the first user and content consumption information of the first user on the messaging application. In some embodiments, the system may store the one or more messages and the determined contextual information on a storage node of a decentralized storage system that may be specific to a transportation service provider of the group of transportation service providers (such as the transport providers).

Based on the determined contextual information and the user data, the system may generate a travel plan. The system may trigger the MaaS network to generate booking details for the trip specified in the travel plan. For example, the booking details may include a date of the trip to the first location, booked flights information, booked hotels information and so forth. The triggering of the MaaS network may correspond to execution of transactions on distributed ledger nodes (such as nodes of the distributed ledger database) of the MaaS network. The system may control the electronic device 118 associated with the first user to display the generated booking details onto the first UI or a second UI different from the first UI.

In accordance with an embodiment, the system may select a messaging group based on the contextual information and the user data. The messaging group may include a group of members with travel interests same as that of the first user. A recommendation to join the messaging group may be displayed on the electronic device associated with the first user. Based on an analysis of conversations between the first user and one or more members of the messaging group, the system may generate the travel plan.

In accordance with an embodiment, the system may receive tracking information from one or more transportation service provider servers (or transportation provider servers). The tracking information may be associated with events that may occur before and during the trip. Based on the tracking information, the system may detect the events. For example, the events may correspond to a start of each leg of a trip that is specified in the travel plan, an end of each leg of the trip, a change in the route or the transportation provider and the like. Based on the tracked events, the system may track a progress of the trip by executing one or more transactions on distributed ledger nodes of the MaaS network.

In some embodiments, the system may receive a user input that may correspond to a request to change or cancel a route, a schedule, or a transportation provider for at least one leg of the trip. The system may trigger the MaaS network to update the booking details based on the user input. The updated booking details may further be rendered as a notification on the electronic device.

In some embodiments, the system may receive a set of inputs from one or more members, including the first user of the messaging group. For example, the set of inputs may be associated with a preference to view or highlight a route undertaken for an active leg of the trip, an itinerary of the trip that is undertaken by the one or more members, location-specific information associated with the first location and other locations in a course of the trip, or one or more tasks to be performed by the one or more members. The system may further generate a live map UI of the trip or an active leg of the trip. Based on the set of inputs, the system may generate a plurality of clickable UI elements. The system may render a first view of the generated live map UI and overlay the plurality of clickable UI elements at corresponding positions on the first view of the rendered live map UI. In such a manner, the first user and the one or more members may click on the plurality of clickable UI elements to perform specific tasks associated with the set of inputs.

In accordance with an embodiment, the system may receive an input corresponding to one or more scheduled tasks associated with the first user. For example, the one or more scheduled tasks may include visit of a site, inspection of a site by the first user, and so forth. The system may generate one or more task widgets corresponding to the one or more scheduled tasks. The generated one or more task widgets may be rendered along with the live map UI of the trip or the active leg of the trip.

In accordance with an embodiment, the system may control, in course of the trip, the electronic device to render a content consumption UI onto the live map UI of the trip. For example, the content consumption UI may include a media player UI which may display a media content, a timeline indicating an amount of the media content that may be already consumed or is yet to be consumed by one or more members, including the first user in the course of the trip, and a viewer UI element which shows the one or more members. In some embodiments, the system may track a consumption of the media content for the one or more members, by executing one or more transactions on distributed ledger nodes of the MaaS network.

In some embodiments, the system may control the electronic device to render a visual planner UI. The render a visual planner UI may include, for example, a first group of UI elements that may graphically represent one or more itinerary items to be covered in a course of the trip, and a second group of UI elements which may correspond to options to configure each of the one or more itinerary items. The system may receive a selection of one or more UI elements of the second group of UI elements. Based on the selection, the travel plan may be updated. The system may trigger the MaaS network to generate the booking details further based on the updated travel plan.

Conventionally, multiple platforms or services may be required by the user to plan a trip, such as for booking the rides, for booking the hotel, and exploring activities in the course of the trip. The system of the present disclosure may enable the user to utilize various services entirely on a single platform. For example, the planning of the trip, starting from a search for a location to travel, to book rides, and to make hotel reservations and transportation arrangements (such as cabs) may be done by use of the system. Thus, the system may provide a hassle free trip planning experience to the user. In conventional systems, user data, such as the personal data of the first user may be shared with various third-parties, such as airline companies. However, the system of the present disclosure may enable local storage of the one or more messages and the contextual information securely at the decentralized storage system. In conventional systems, management and tracking of payments for various services may be a difficult task for the user and voice-based commands may be absent for payment services. The system of the present disclosure may enable user-friendly management and tracking of all payments of the trip on the single platform. The system may further enable voice-based commands for authentication of the first user and for facilitation of payments on the platform. Furthermore, the system may provide different UIs, such as the chat UI that may provide a holistic experience to the user.

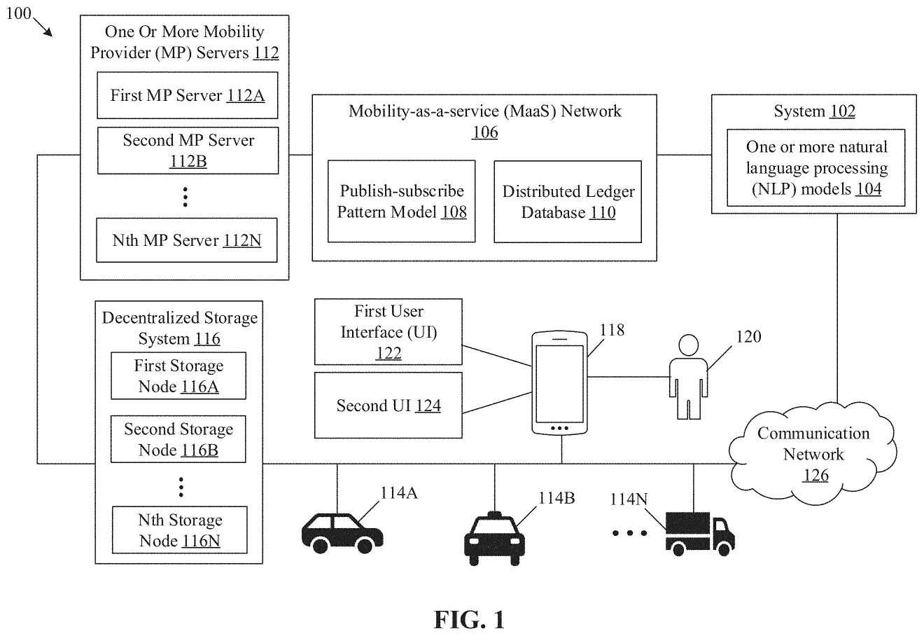

FIG. 1 is a diagram of an exemplary network environment for providing a conversational user experience for a multimodal travel system, in accordance with an embodiment of the disclosure. With reference to FIG. 1, there is shown a diagram of a network environment 100. The network environment 100 may include a system 102. The system 102 may include one or more NLP models 104. The network environment 100 may further include a MaaS network 106. The MaaS network 106 may include a publish-subscribe model 108 and a distributed ledger database 110. The network environment 100 may further include one or more mobility provider (MP) servers 112, such as a first MP server 112A, a second MP server 112B, and an Nth MP server 112N. The network environment 100 may further include a group of vehicles, such as a first vehicle 114A, a second vehicle 114B, and an Nth vehicle 114N. The network environment 100 may further include a decentralized storage system 116 that may include a first storage node 116A, a second storage node 116B, and an Nth storage node 116N. Further, the network environment 100 may include an electronic device 118 associated with a first user 120, a first user interface (UI) 122, and a second UI 124 associated with the electronic device 118. The network environment 100 may further include a communication network 126. The system 102, the MaaS network 106, the one or more MP servers 112, the decentralized storage system 116, the electronic device 118 and the group of vehicles may communicate via the communication network 126.

The system 102 may include suitable logic, circuitry, code, and/or interfaces that may be configured to provide an interface (such as a the first UI 122 or the second UI 124) for users to chat about a travel plan and to track a trip included in the travel plan through various options, such as a map-based interface. Based on the travel plan, the system 102 may trigger the MaaS network 106 to generate the booking details. The system 102 may control the electronic device 118 to display the generated booking details onto the first UI 122 or the second UI 124. Example implementations of the system 102 may include, but are not limited to, a virtual machine (VM) on a host machine, a container or a virtual runtime environment of an Operating System (OS) on a host machine or server, a containerized application on a server, a BareMetal server, a cloud server (such as a private, a public or a hybrid cloud), a workstation, a media server, or any device with a capability to generate and stream media content to a cluster of devices. In an embodiment, the system 102 may be implemented as a VM or container on a server or a server node of the one or more MP servers 112.

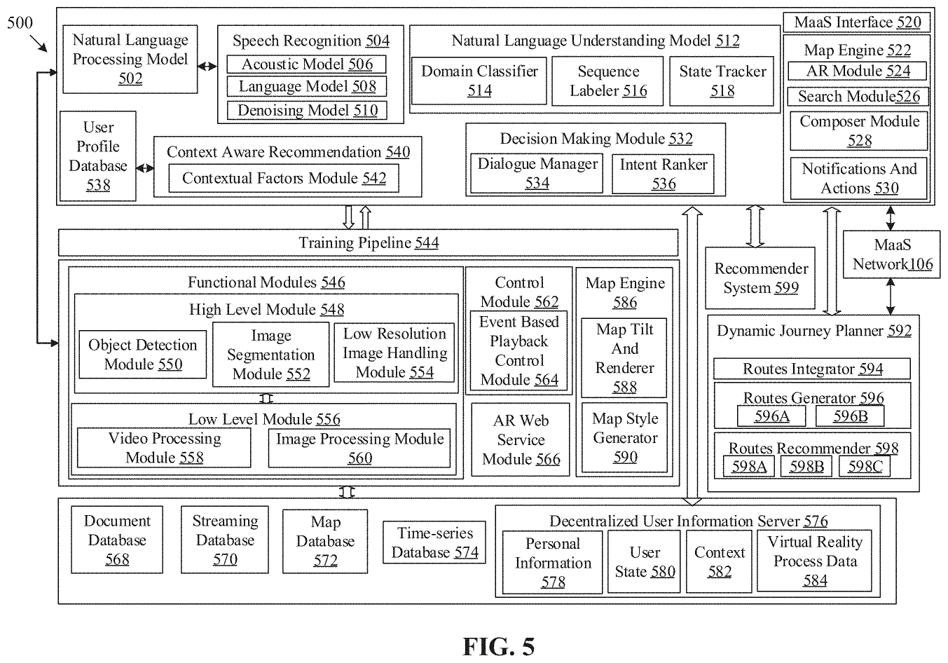

The one or more NLP models 104 may be machine learning or statistical models that may be configured to analyze one or more messages from the first user 120 to determine contextual information. Such messages may include a natural language input that may correspond to at least one of a voice-based conversation, a video-based conversation, or a text-based conversation between the first user 120 and one or more recipients of the one or more messages. The one or more NLP models 104 may be artificial intelligence (AI) based models. The one or more NLP models 104 may enable a time-efficient and user-friendly communication between the first user 120 and the one or more recipients. The one or more NLP models 104 may further provide sharing ideas between the first user 120 and the one or more recipients. Examples of NLP techniques that may be utilized by the one or more NLP models 104 to analyze the one or more messages may include, but are not limited to, a context extraction, an automatic summarization, a sentiment analysis, a parts-of-speech tagging, a semantic relationship extraction, a stemming, a text mining, and a machine translation. Details of an exemplary architecture of the one or more NLP models 104 are further described, for example, in FIG. 5.

The MaaS network 106 may support a standard specification for communication and may include the publish-subscribe model 108. The publish-subscribe model 108 may include publisher nodes (e.g., ticket readers or ride booking applications), subscriber nodes, and at least one broker node device to communicate transaction messages from the publishers nodes to the subscriber nodes, in accordance with a publish-subscribe network protocol, such as Message Queuing Telemetry Transport. In at least one embodiment, the MaaS network 106 may include the distributed ledger database 110 which may include ledger nodes to record transactions associated with various mobility services, such as ticketing transactions of a MaaS transportation service, payments towards various services and tracked progress of the trip.

The publisher nodes of all transportation service providers associated with the MaaS network 106 may follow a standard or common communication protocol for data exchange. The MaaS network 106 may include homogeneous publisher nodes that may follow the MaaS standard specification for communication. In an embodiment, the MaaS network 106 may include heterogeneous publisher nodes that may follow proprietary communication protocols. The MaaS network 106 may offer a plug-in based support to the publisher nodes so that such heterogeneous publisher nodes can be supported until respective transportation service providers adhere to and provide support for the MaaS standard specification for communication.

The MaaS network 106 may enable the publisher nodes associated with different transportation providers to join the MaaS network 106. Through a node management device, the MaaS network 106 may provide bulk cluster management of the publisher nodes. All the publisher nodes may follow set protocols to operationalize on the MaaS network 106. The set protocols may mandate a common security architecture (for publisher node authentication and authorization), a network protocol (e.g., HTTP, MQTT, AMQP, and the like), a uniform data request or response format (e.g., JSON, CSV, or XML format), and an API/data scheme. This may ensure that each publisher node follows a cluster-level configuration (such as a device profile including a company name, a company ID, a gate ID, a gate number, and the like) and a device-level certificate (i.e., the authentication credential). The pattern of cluster-level configuration and the set protocols may facilitate transport providers to deploy new publisher nodes or replace existing publisher nodes with a plug-and-play approach. This may facilitate the MaaS network 106 to function as a homogeneous transportation network with interoperability between resources (such as publisher node devices) of the various transportation providers.

The one or more MP servers 112 may include suitable logic, circuitry, code and/or interfaces that may be configured to collectively manage transport/mobility services for trips planned by an individual user or a group of users. For example, the first MP server 112A may be configured to manage the transport/mobility services for a first transportation service provider. The second MP server 1128 may be configured to manage the transport/mobility services for a second transportation service provider. Similarly, the Nth MP server 112N may be configured to manage the transport/mobility services for an Nth transportation service provider. Each of the one or more MP servers 112 may be implemented as a cloud server and may execute operations through web applications, cloud applications, HTTP requests, repository operations, file transfer, and the like. Other example implementations of each of the one or more MP servers 112 may include, but are not limited to, a database server, a file server, a web server, a media server, an application server, a mainframe server, or a cloud computing server. In at least one embodiment, each of the one or more MP servers 112 may be implemented as a plurality of distributed cloud-based resources by use of several technologies that are well known to those ordinarily skilled in the art.

The group of vehicles, such as the first vehicle 114A, the second vehicle 114B and the Nth vehicle 114N may be owned, leased, or managed by a transportation service provider associated with the MaaS network 106. Each of such vehicles may be offered as part of a public transportation service or a private transportation service. When the first user 120 books a trip through the MaaS network 106, the trip may be divided into legs, which may be covered through one or more modes of transport, such as the first vehicle 114A, the second vehicle 114B, and the Nth vehicle 114N. Examples of such modes of transport may include, but are not limited to, a rail, a bus, a car, an airplane, a taxi or a cab, a trolley, a tram, a ferry, a rapid transit, a truck, or a bike.

In FIG. 1, the depiction of the group of vehicles, such as the first vehicle 114A, the second vehicle 1148 and the Nth vehicle 114N as a car, a taxi, and a truck is merely provided as an example, and should not be construed as limiting the disclosure. The present disclosure may be applicable to vehicles associated with other available modes of public or private transport.

The decentralized storage system 116 may include suitable logic, circuitry, code, and/or interfaces that may be configured to store transaction data associated with a respective transportation service provider. For example, the first storage node 116A may store transaction data associated with a first transportation service provider. The transaction data may include records of past trips of users (such as the first user 120) and recent and past message or chat records with a travel context. Each trip may correspond to a MaaS transportation service that may be provided by the first transportation provider (for example, associated with the first MP server 112A) in at least one leg of the trip. Each storage node of the decentralized storage system 116 may be referred to as a node of the decentralized storage system 116 that may store transaction data of the various transportation service providers of the MaaS network 106. The decentralized storage system 116 may enable the users of different messaging clients to connect with the system 102. The decentralized storage system 116 may enable secure storage of data associated with each user and may allow an end-to-end encryption of messages between users.

The electronic device 118 may be a user device that may include suitable logic, circuitry, and interfaces that may be configured to display a UI, such as the first UI 122 or the second UI 124 which may enable users to chat, create travel groups, decide on travel plans, accept travel plan suggestions, trigger the booking of accepted travel plans, and track trips included in the travel plans. The electronic device 118 may be controlled to display booking details associated with one or more travel plans, onto the first UI 122 or the second UI 124. In some embodiments, the electronic device 118 may include a web application or a mobile application. In such a case, the first UI 122 or the second UI 124 may be rendered as part of the web application or the mobile application. Examples of the electronic device 118 may include, but are not limited to, a computing device, a smartphone, a mobile phone, a public display (such as a public kiosk), an eXtended Reality (XR) device, a gaming device, a mainframe machine, a server, a computer work-station, and/or a consumer electronic (CE) device.

The first UI 122 and the second UI 124 may be rendered on a display screen, such as a display screen of the electronic device 118. In an embodiment, the first UI 122 may be a chat UI and the second UI 124 may include a map UI element.

The communication network 126 may include a communication medium through which the system 102, the MaaS network 106, the one or more MP servers 112, the group of vehicles, the decentralized storage system 116 and the electronic device 118 may communicate with each other. The communication network 126 may be one of a wired connection or a wireless connection. Examples of the communication network 126 may include, but are not limited to, the Internet, a cloud network, Cellular or Wireless Mobile Network (such as Long-Term Evolution and 5G New Radio), a Wireless Fidelity (Wi-Fi) network, a Personal Area Network (PAN), a Local Area Network (LAN), or a Metropolitan Area Network (MAN). Various devices in the network environment 100 may be configured to connect to the communication network 126 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

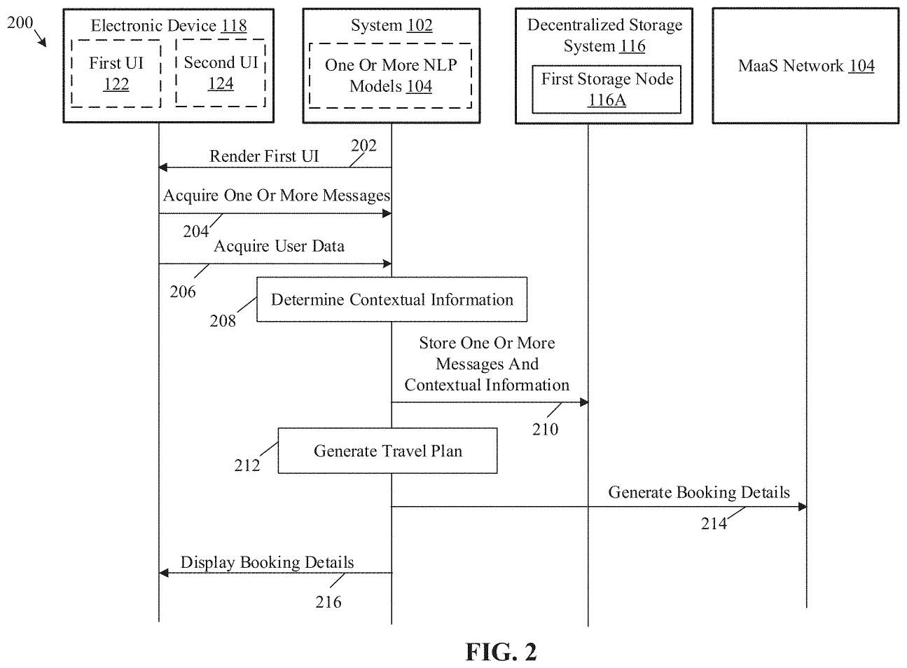

In operation, a networking application may be accessed on the electronic device 118. The networking application may be, for example, a social networking application, a microblogging application, a chat application, a messaging application, a Voice over Internet Telephony (VoIP) application, and the like. The system 102 may control the electronic device 118 (such as a smartphone) associated with the first user 120 to render the first UI 122. The first UI 122 may be associated with the networking application and the first user 120 may be a registered user of the networking application. In some embodiments, the first UI 122 may be rendered as a chat UI. Details associated with the render of the first UI 122 are further described, for example, in FIG. 2.

At any time-instant, the first user 120 may message one or more users, who may be part of a group of family and friends or may be members of a social group. The system 102 may acquire one or more messages that may include a natural language input from the first user 120. Such messages may be acquired through the first UI 122. In one or more embodiments, the natural language input may correspond one of a voice-based conversation, a video-based conversation, or a text-based conversation between the first user 120 and one or more recipients of the one or more messages. For example, the first user 120 may utilize the first UI 122 to chat regarding a location for a trip with the one or more users (who may be recipients of the one or more messages). Details of the acquisition of the one or more messages are further described, for example, in FIG. 2.

The system 102 may acquire user data associated with the first user 120. In accordance with an embodiment, the user data may include personal information (such as a name of the first user 120, a current location of the first user 120, a communication address of the first UI 122, an electronic mail (e-mail) of the first user 120). The user data may also include a set of user preferences (such as preferred travel locations), a travel history (such as previously visited locations), and content consumption information (such as a usage history of the networking application). The user data may also include user generated content in a context of locations covered in the trip and social data, including but not limited to, a chat history, a set of past interactions with members of one or more messaging groups, a social context of each conversation recorded in the chat history, and a group of people in a social network of the first user 120. Details of the acquisition of the user data are further described, for example, in FIG. 2.

The system 102 may process the acquired one or more messages using the one or more NLP models 104 to determine contextual information. In some embodiments, the one or more NLP models 104 may be AI or machine learning models, statistical Markov models (such as a Hidden Markov Model), or heuristic models for NLP. The contextual information may indicate an intent of the first user 120 to travel to a first location and a schedule associated with the travel. For example, the contextual information may include a name of the first location preferred by the first user 120 and a preferred date/time of visit to the first location. Details of the determination of the contextual information are further described, for example, in FIG. 2.

Based on the determined contextual information and the user data, the system 102 may generate a travel plan. In some embodiments, the travel plan may include an itinerary of a trip for each of the first user 120 and the one or more members undertaking the trip to the first location. For example, the travel plan may include information on different places (for example, famous monuments) to visit at the first location and information on preferred activities (for example, bungee jumping and paragliding). Details of the generation of the travel plan are further described, for example, in FIG. 2.

The system 102 may trigger the MaaS network 106 to generate booking details for the trip specified in the travel plan. For example, the booking details may include a date of the trip to the first location, a schedule for each leg of the trip, a transport service to be used in each leg, and a location and time to board a vehicle that may be reserved or expected to be available for each leg of the trip. If the trip requires a flight to travel to the first location, then the booking details may include details (such as a flight name, a boarding location, and flight departure and arrival timings) of booked flights and hotels booked for stay. The triggering of the MaaS network 106 may correspond to execution of transactions on distributed ledger nodes (such as nodes of the distributed ledger database 110) of the MaaS network 106. The execution of transactions may be performed to record details of the trip (as part of the travel plan) for each user on the distributed ledger nodes. Based on the execution, the MaaS network 106 may be configured to track at least a start and end of each leg of the trip, a location of each user at all times within the duration of the trip, and delivery of other services, such as ticketing, payment, or media consumption. Details of the generation of the booking details are further described, for example, in FIG. 2.

The system 102 may control the electronic device 118 associated with the first user 120 to display the generated booking details onto the first UI 122 or the second UI 124. The second UI 124 may be different from the first UI 122. For example, the first UI 122 may be the chat UI and the second UI 124 may include a map UI element. Details of the display of the generated booking details are further described, for example, in FIG. 2.

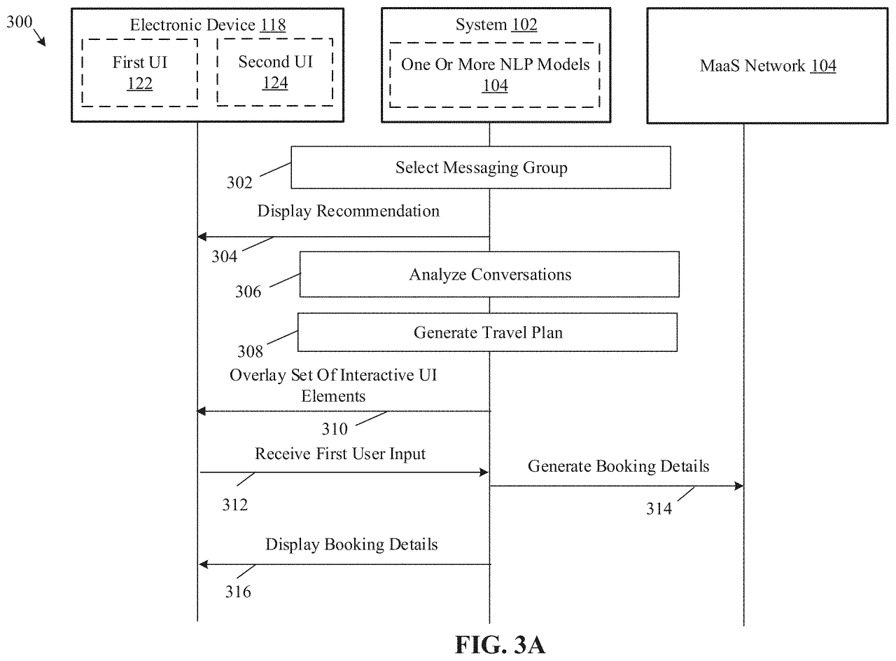

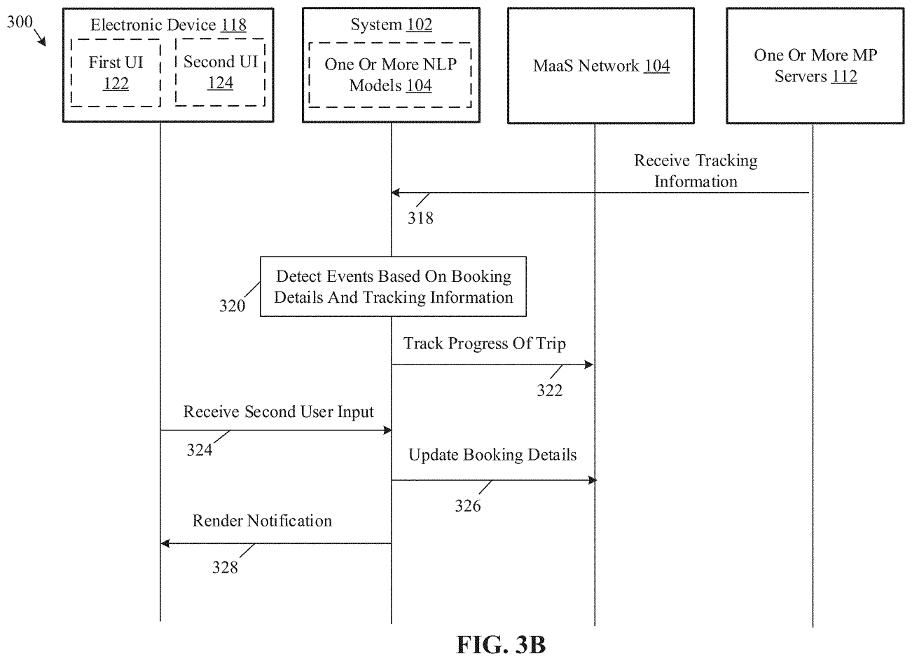

In accordance with an embodiment, the system 102 may select a messaging group based on the contextual information and the user data. As an example, the messaging group may be selected based on the user preference and behavioral data of the first user 120 in the user data. The messaging group may further be selected based on a social context, for example, an organization (such as office) of the first user 120, a location of residence of the first user 120, a family group of the first user 120, and a friend circle of the first user 120. Moreover, the messaging group may be selected based on user profiles of the users who may have interacted with or may be in a friend list of the first user 120 on the networking application. The messaging group may include a group of members with travel interests same as that of the first user 120. For example, the messaging group may include a group of members whose preferred travel location may be in Europe. In an embodiment, the messaging group may be associated with family trips, trips with friends/coworkers, work-related trips, housing society trips, and the like. A recommendation to join the messaging group may be displayed on the electronic device 118 associated with the first user 120. Based on an analysis of conversations between the first user 120 and one or more members of the messaging group, the system 102 may generate the travel plan. Details of the selection of the messaging group are further described, for example, in FIG. 3A.

In accordance with an embodiment, the system 102 may overlay a set of interactive UI elements onto the first UI 122 or the second UI 124. For example, the set of interactive UI elements may correspond to a shared schedule associated with the trip for the first location, a poll to determine whether or not to plan an activity in a course of the trip, or items of shared interest associated with the one or more locations. In some embodiments, the second UI 124 may include a map UI element onto which the set of interactive UI elements may be overlaid. Details of the overlay of the set of interactive UI elements are further described, for example, in FIG. 3A.

In accordance with an embodiment, the system 102 may receive tracking information from the one or more MP servers 112. The tracking information may be associated with events that may occur before and in a course of the trip. Based on the tracking information, the system 102 may detect the events. For example, the events may correspond to a start of each leg of a trip that is specified in the travel plan, an end of each leg of the trip, a change in the route or the transportation service provider and the like. Based on the tracked events, the system 102 may track a progress of the trip by executing one or more transactions on distributed ledger nodes of the MaaS network 106. Details of the reception of the tracking information and detection of the events are further described, for example, in FIG. 3B.

In some embodiments, the system 102 may receive a user input that may correspond to a request to change or cancel a route, a request to change or cancel a schedule, or a request to change or cancel a transportation provider for at least one leg of the trip. For example, the first user 120 may need to skip visit to a specific city included in the travel plan. The system 102 may receive the user input that may correspond to a request to cancel the visit to the specific city included in the travel plan. The system 102 may trigger the MaaS network 106 to update the booking details based on the user input. The updated booking details may further be rendered as a notification on the electronic device 118. Details of the update of the booking details are further described, for example, in FIG. 3B.

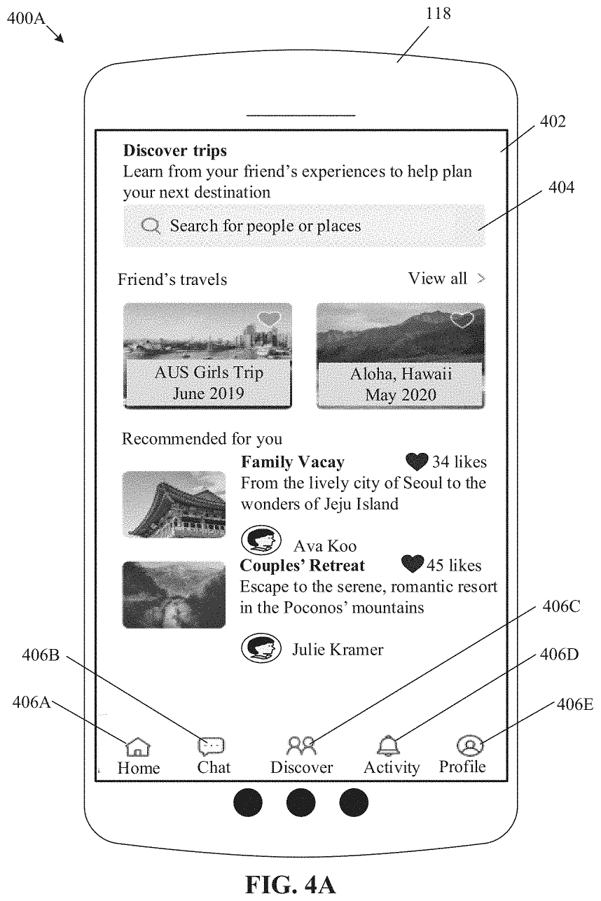

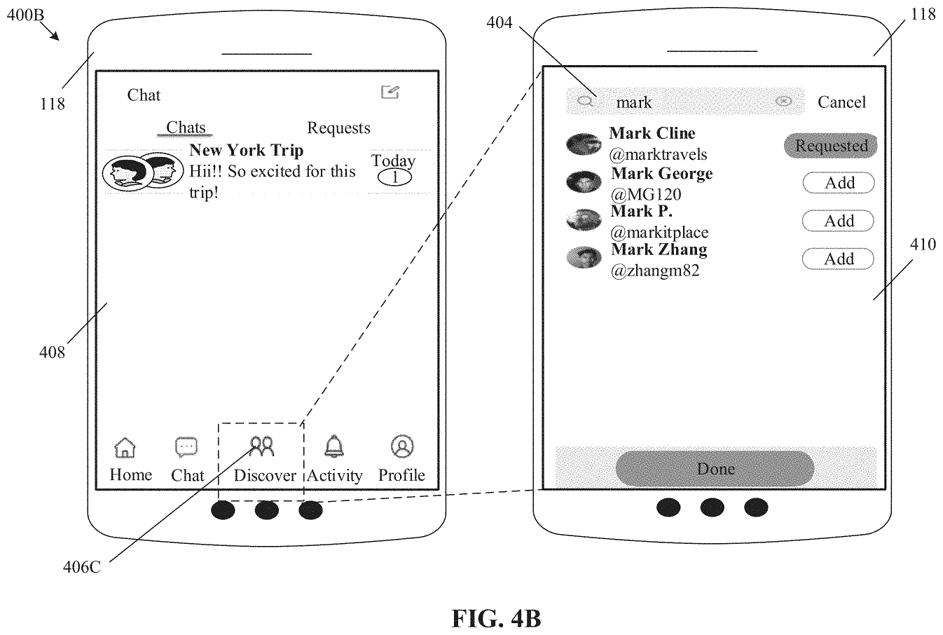

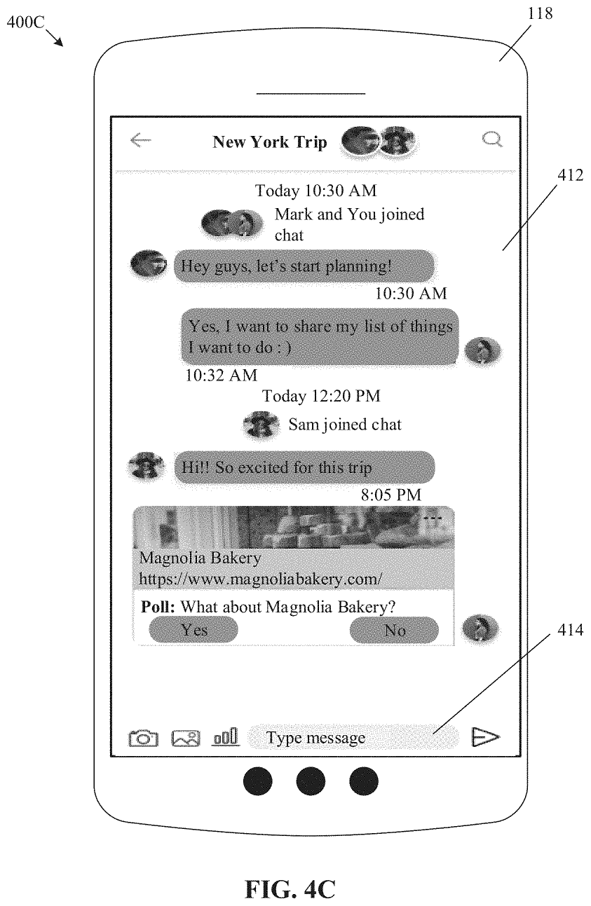

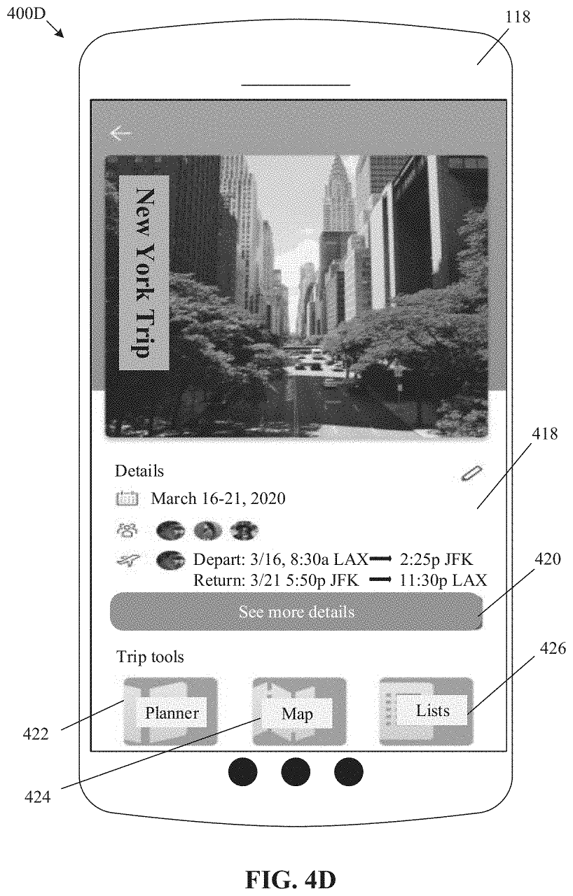

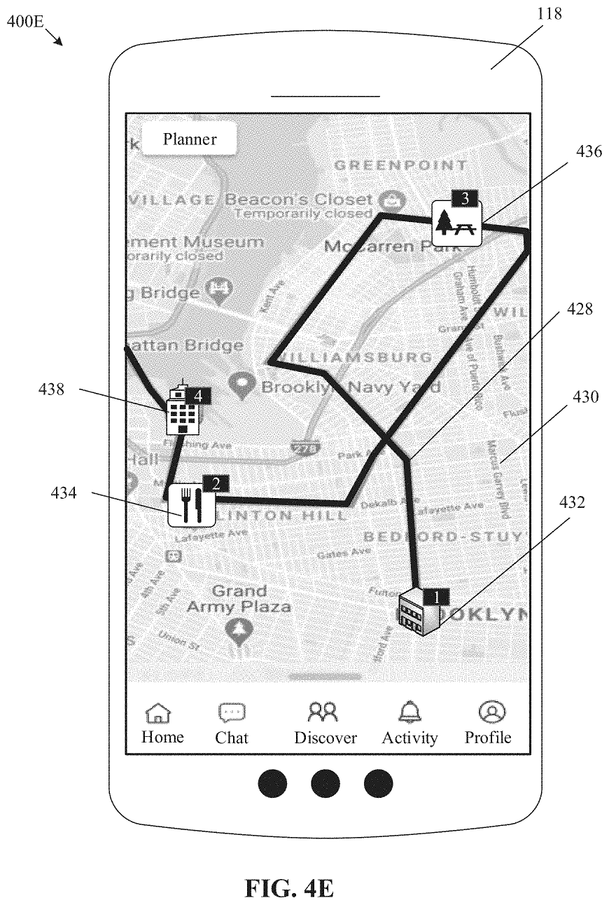

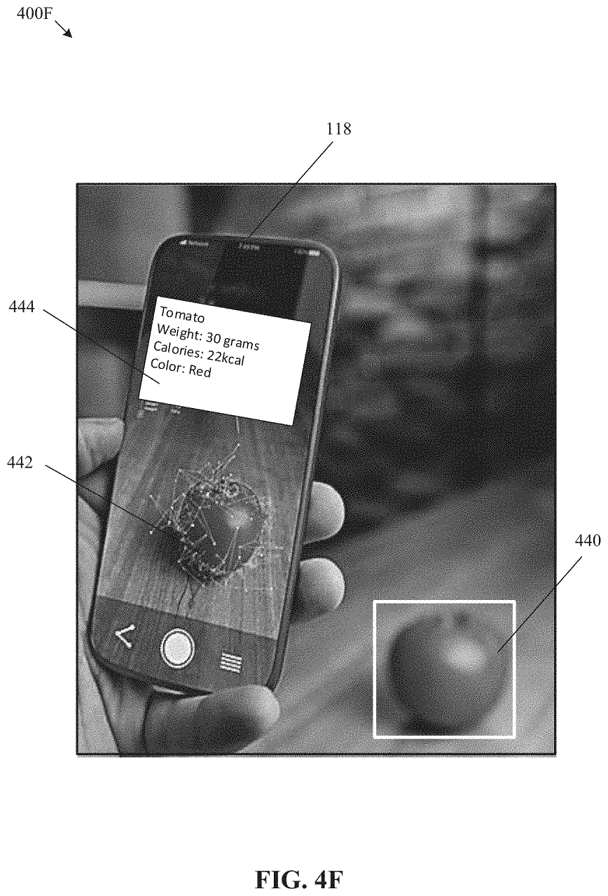

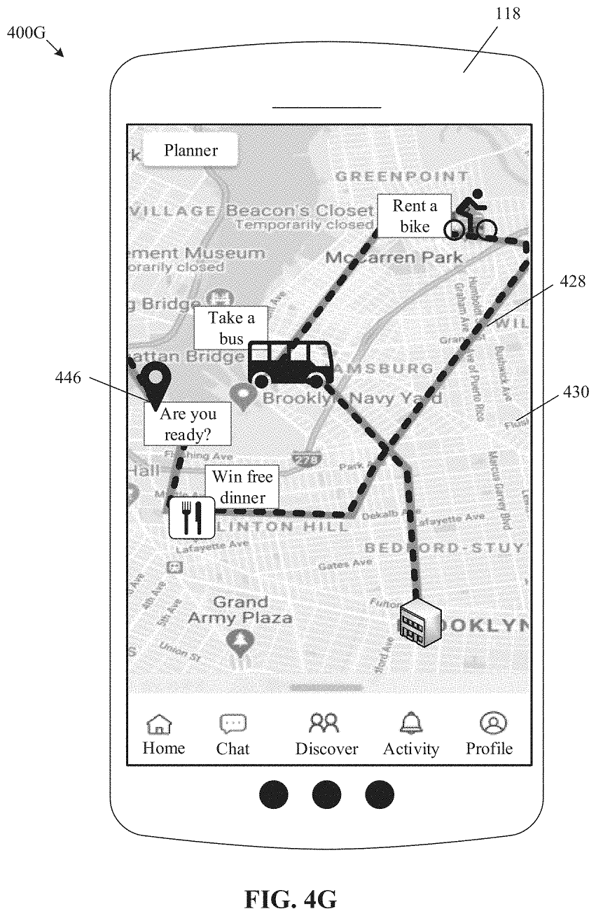

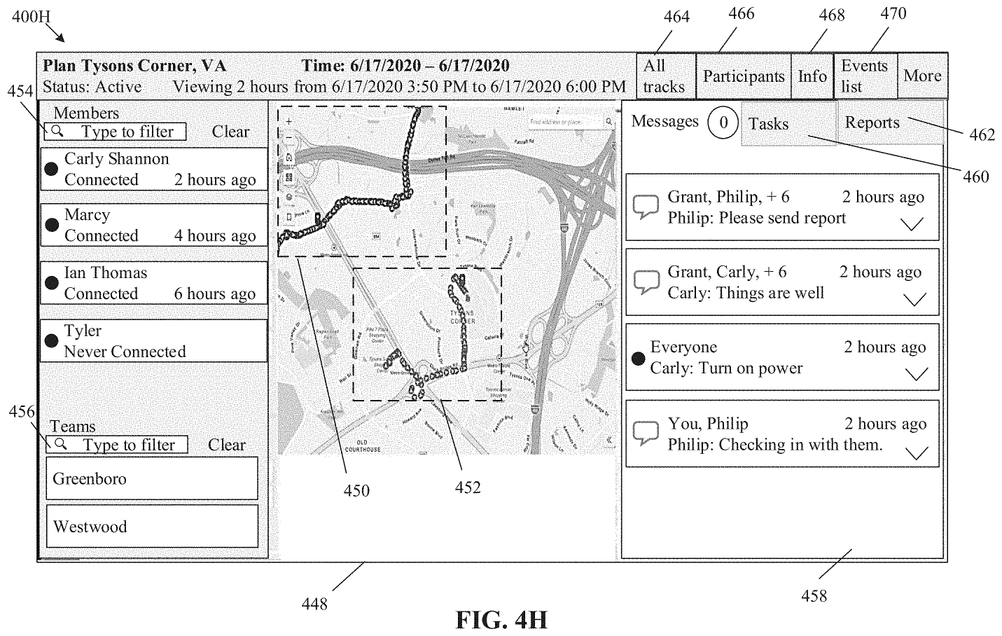

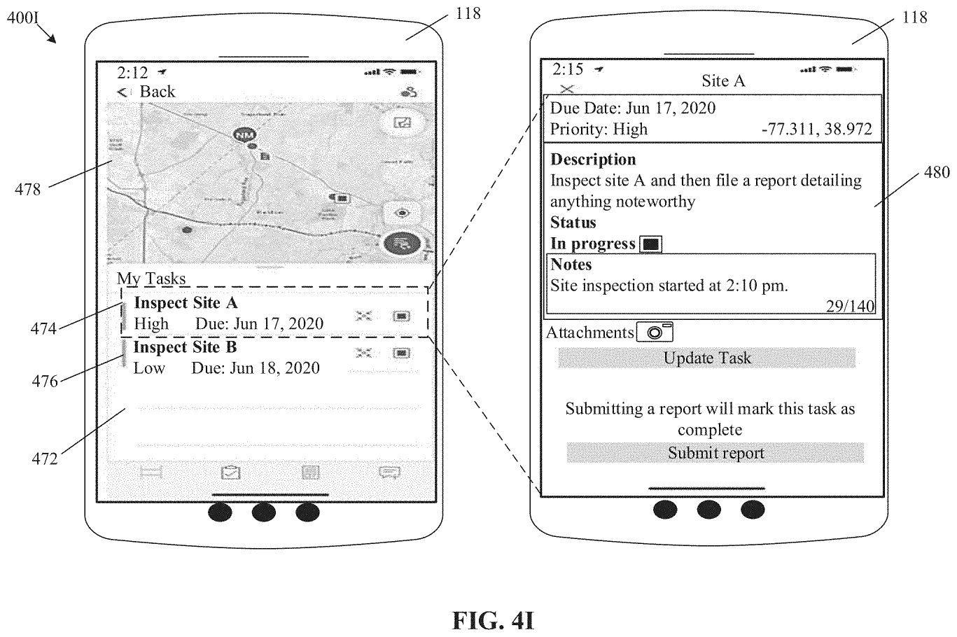

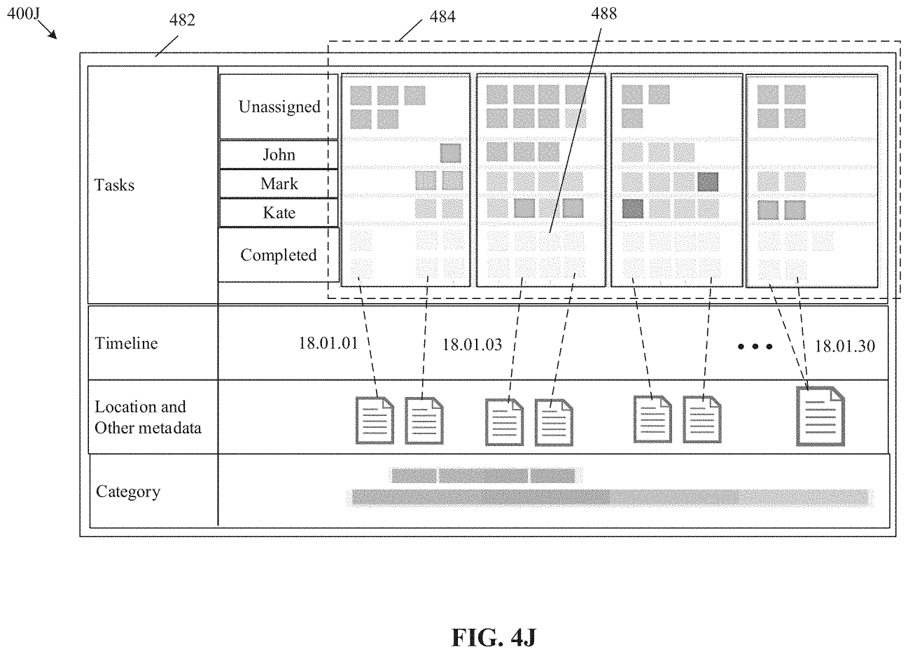

In one or more embodiments, the system 102 may generate a set of interactive augmented reality (AR) elements. For example, the set of interactive AR elements may be based on visited locations of the trip, a current location or a future location to be visited in the course of the trip, conversations between the first user 120 and one or more members in the course of the trip, one or more advertisements, and the like. For example, the generated set of AR elements may include an AR element that corresponds to a monument visited by the first user 120. The generated set of AR elements may be rendered onto the first UI 122 or the second UI 124. Details of the generation of the set of interactive AR elements are further described, for example, in FIG. 4F.

In some embodiments, the system 102 may receive a set of inputs from one or more members, including the first user 120 of the messaging group. For example, the set of inputs may be associated with a preference to view or highlight a route undertaken for an active leg of the trip, an itinerary of the trip that may be undertaken by the one or more members, location-specific information associated with the first location and other locations covered or to be covered in a course of the trip, and one or more tasks to be performed by the one or more members. The system 102 may generate a live map UI of the trip or an active leg of the trip.

Based on the set of inputs, the system 102 may generate a plurality of clickable UI elements. For example, the system 102 may receive an input of the set of inputs corresponding to a request to highlight of the route. The system 102 may render a first view of the generated live map UI and may overlay the plurality of clickable UI elements at corresponding positions on the first view of the rendered live map UI. The plurality of clickable UI elements may be generated on the highlighted route that may be utilized by the first user 120 for different activities. The first user 120 and the one or more members may click on the plurality of clickable UI elements to perform specific tasks associated with the set of inputs. Details of the generation of the plurality of clickable UI elements are further described, for example, in FIG. 4E.

In accordance with an embodiment, the system 102 may receive a selection of a first clickable UI element of the overlaid plurality of clickable UI elements. Based on the received selection, the system 102 may switch the rendered first view to a second view of the live map UI. For example, the first clickable UI element may correspond to a restaurant. The second view may correspond to a view of a map that displays a route between a current location of the first user 120 and a location of the restaurant. In some embodiments, the plurality of clickable elements may include one or more AR elements. Details of the switching of the rendered first view to the second view are further described, for example, in FIG. 4G.

In accordance with an embodiment, the system 102 may receive a selection of a second clickable UI element of the overlaid plurality of clickable UI elements. Based on the selection, the system 102 may overlay a chat window UI onto the live map UI. The chat window UI may enable communication between the first user 120 and a member of the messaging group. For example, the chat window UI may be used by the first user 120 or the member of the messaging group to instantly communicate with each other while viewing a live location of each other. Details of the overlay of the chat window UI are further described, for example, in FIG. 4G.

In accordance with an embodiment, the system 102 may receive an input corresponding to one or more scheduled tasks associated with the first user 120. For example, the one or more scheduled tasks may include a visit to a site, an inspection of a site by the first user 120, and the like. The system 102 may generate one or more task widgets corresponding to the one or more scheduled tasks. The generated one or more task widgets may be rendered along with the live map UI of the trip or the active leg of the trip. For example, the one or more task widgets may correspond to activities to be performed by the first user 120 in a day, such as to visit the site, complete a project, or attend a meeting. Details of the generation of the one or more task widgets are further described, for example, in FIGS. 4H and 4I.

In accordance with an embodiment, the system 102 may control, in course of the trip, the electronic device 118 to render a content consumption UI onto the live map UI of the trip. For example, the content consumption UI may include a media player UI which may display media content, a timeline indicating an amount of the media content that may be already consumed or is yet to be consumed by one or more members, including the first user 120 in the course of the trip, and a viewer UI element which shows the one or more members. In some embodiments, the system 102 may track a consumption of the media content for the one or more members, by executing one or more transactions on the distributed ledger nodes of the MaaS network 106. Details of the render of the content consumption UI are further described, for example, in FIG. 4J.

In some embodiments, the system 102 may control the electronic device 118 to render a visual planner UI. The render a visual planner UI may include, for example, a first group of UI elements that may graphically represent one or more itinerary items to be covered in a course of the trip, and a second group of UI elements which may correspond to options to configure each of the one or more itinerary items. The system 102 may receive a selection of one or more UI elements of the second group of UI elements. Based on the selection, the travel plan may be updated. The system 102 may trigger the MaaS network 106 to generate the booking details further based on the updated travel plan. Details of the render of the visual planner UI are further described, for example, in FIG. 4J.

FIG. 2 is an exemplary sequence diagram that depicts a conversational user experience for a multimodal travel system, in accordance with an embodiment of the disclosure. FIG. 2 is explained in conjunction with elements from FIG. 1. With reference to FIG. 2, there is shown a sequence diagram 200 that illustrates a sequence of operations from 202 to 216. The sequence of operations may be executed by the system 102, the electronic device 118, the decentralized storage system 116, or the MaaS network 106 of FIG. 1.

At 202, the system 102 may control the electronic device 118 associated with the first user 120 to render the first UI 122. The first UI 122 may be associated with a networking application and the first user 120 may be a registered user of the networking application. An exemplary interface of the networking application is further described, for example, in FIG. 4A.

In accordance with an embodiment, the first UI 122 may be the chat UI. For example, the chat UI may be utilized by the first user 120 to communicate with one or more members (such as users) registered on the networking application. In an exemplary scenario, the networking application may include a plurality of chat UIs. For example, a first chat UI of the plurality of chat UIs may be dedicated to a family group of the first user 120. A second chat UI of the plurality of chat UIs may be dedicated to a group of friends of the first user 120. A third chat UI of the plurality of chat UIs may be dedicated to a specific user, such as a close friend or wife.

In some embodiments, the chat UI may be rendered based on a selection of a contact name or a selection of a previously rendered chat UI (indicative of a recent chat) from the plurality of chat UIs. Details of the first UI 122 as the chat UI are further described, for example, in FIGS. 4B and 4C.

At 204, the system 102 may acquire one or more messages through the first UI 122. The one or more messages may include a natural language input from the first user 120. In accordance with an embodiment, the natural language input may correspond one of a voice-based conversation, a video-based conversation, or a text-based conversation between the first user 120 and one or more recipients of such messages. For example, as a chat UI, the first UI 122 may be used by the first user 120 to communicate with the one or more recipients. The one or more messages may correspond to a text-based conversation on a plan for a 2-day trip to New York in early August. A text message may be posted by the first user 120 on the rendered chat UI to plan the trip to New York. For example, the text message may be “Hey, let us plan a vacation to New York”. In response to the text message, the one or more recipients may respond on the chat UI. For example, the response may be in the form of a text message, a voice message, or a video message. In some embodiments, a uniform resource locator (URL) associated with the travel location as New York may be shared by the first user 120 with the one or more recipients in the chat UI. Details of the chat UI with one or more messages are further described, for example, in FIG. 4C.

In an embodiment, the system 102 may utilize the voice-based conversation (or voice-based commands) to assist the first user 120 during the trip. The voice-based commands may be set up by the first user 120. For example, voice-based commands such as “Share content with my team members”, “Request content from Donald”, “Pay for beverage” and “Start poll with managers” may be used for assistance during the trip. In an example, the system 102 may interface bots with the MaaS network 106 for MaaS related queries and commands. For example, voice-based commands such as “Remind me 10 mins before my stop” may be used by the first user 120. Voice-based authentication may further be utilized to enable payments during the trip. The voice-based authentication may be also utilized for user identification and authorization of the payments. By way of example, and not limitation, a voice-based command “Send money” may be received by the system 102. The system 102 may transmit a request for the transaction to a server of a bank and may receive a request to authenticate the first user 120 from the server of the bank. The system 102 may transmit a notification to the electronic device 118 associated with the first user 120. The system 102 may receive the voice-based authentication from the first user 120 and may transmit the voice-based authentication to the server of the bank. Based on a receipt of the voice-based authentication, the server of the bank may authorize the transaction.

At 206, the system 102 may acquire user data associated with the first user 120. In accordance with an embodiment, the user data may include personal information of the first user 120. Examples of the personal information may include, but are not limited to, the name of the first user 120, a registered e-mail ID of the first user 120, a contact number of the first user 120, a current location of the first user 120, and an address of the first user 120. The user data may further include a set of user preferences. The set of user preferences may include, for example, a preference for a travel location, a preference of a hotel at the location of travel, a preference of a mode of transport, a preferred period in a year (such as a specific month or a week) for travel, and the like. The user data may also include a travel history of the first user 120. For example, the travel history may include places (such as cities or countries) visited by the first user 120, details of past few vacations, and daily travel information (such as a route travelled to reach an office) of the first user 120.

In an embodiment, the user data may include a set of content preferences, such as types of movies or shows preferred by the first user 120, and a type of music preferred by the first user 120. The user data may include content consumption information, such as previously viewed movies and played music. The user data may also include user generated content in context of locations covered in a trip. For example, the user generated content may include one or more images captured by the first user 120 at the location of travel and one or more videos recorded by the first user 120 at the location of travel. The user generated content may further include a history of conversation (such as a chat history) of the first user 120 with other users on the networking application.

The user data may further include social data, including but not limited to, a chat history, a set of past interactions with members of one or more messaging groups, a social context of each conversation recorded in the chat history, and a group of people in a social network of the first user 120. For example, the group of people in the social network may be family members of the first user 120, friends of the first user 120, office colleagues of the first user 120, and the like. The social context of each conversation with each of the group of people may be included in the user data.

At 208, the system 102 may process the acquired one or more messages using the one or more NLP models 104 to determine the contextual information. The contextual information may indicate an intent of the first user 120 to travel to a first location and a schedule associated with the travel. The one or more messages may be input to the one or more NLP models 104. The one or more NLP models 104 may process the one or more messages to output the contextual information. For example, the system 102 may input a message “Lets plan a trip to New York” to an NLP model. The contextual information output by the NLP model may include “the first user 120 wants to plan the trip to New York city with a second user”.

In accordance with an embodiment, the contextual information may further indicate a social context associated with the one or more messages. The social context may indicate a social setting in which the first user 120 may interact with the one or more recipients of the one or more messages. The contextual information may further indicate a social relationship with one or more recipients of the one or more messages. As an example, the first user 120 may be a colleague of the one or more recipients of the messages. The social context may indicate that the trip to New York is a business trip with the colleagues. As another example, the first user 120 may be friends with the one or more recipients of the messages. The social context may indicate that the trip to New York is a vacation with friends. Details of the exemplary architecture of the one or more NLP models 104 are further described, for example, in FIG. 5.

At 210, the system 102 may store the acquired one or more messages and the determined contextual information on a storage node (such as the first storage node 116A) of the decentralized storage system 116. The storage on each node of the decentralized storage system 116 may be specific to a transportation service provider of the group of transportation service providers. For example, the first transportation service provider may be utilized by the first user 120. The acquired one or more messages and the determined contextual information associated with the first user 120 may be stored locally on the first storage node 116A. This may be done to securely store user-specific data and to maintain a privacy of the first user 120.

In an embodiment, the one or more messages, the contextual information, a status (such as online availability) of the first user 120, and the user data may be stored on the first storage node 116A. Similarly, messages associated with the one or more recipients, contextual information associated with the one or more recipients, status (such as an online availability) of the one or more recipients, and user data of the one or more recipients may be stored on a respective storage node of the decentralized storage system 116.

At 212, the system 102 may generate a travel plan based on the contextual information and the user data. In accordance with an embodiment, the travel plan may include an itinerary of the trip for each of the first user 120 and the one or more recipients undertaking the trip to the first location. In an exemplary scenario, the travel plan may include places to visit at the first location (such as New York). The places may include famous monuments, restaurants, amusement parks, theatres, museums, and the like. The travel plan may further include a date and a time corresponding to visit at each place. The travel plan may further include a total duration of a journey to the first location, a date and time of arrival at the first location and a date and time of departure from the first location. Details of an exemplary first UI for the travel plan are further described, for example, in FIG. 4D.

At 214, the system 102 may trigger the MaaS network 106 to generate the booking details for the trip specified in the generated travel plan. The system 102 may transmit or share booking data associated with the first user 120 to the MaaS network 106. The booking data may include, for example, the user data, such as the name of the first user 120 and the contact number of the first user 120. The booking data may further include payment details for a transport service to be used for each leg of the trip and payment details for location, such as hotels to be used for a stay in the duration of the trip. Based on the transmitted booking data, a transaction record may be created on the MaaS network 106. The system 102 may generate the booking details based on the created transaction record.

In an exemplary scenario, the booking details may include a date of travel of the first user 120 to the first location, a departure flight information, an arrival flight information, multi-modal transport services to be used for several legs of the trip, hotel check-in details, hotel check-out details, and the like. Details of the generation of the booking details are further described, for example, in FIGS. 3A and 3B.

The distributed ledger database 110 may store the details, such as trip confirmation details (for example, a ticket identification (ID) number), trip change details (such as changes requested in the trip), details of confirmation of the travel plan, a consensus on attending an event by the first user 120 and the one or more members, a status of a task, and payment details.

At 216, the system 102 may control the electronic device 118 to display the generated booking details onto the first UI 122 or the second UI 124. The second UI 124 may be different from the first UI 122. For example, the booking details may be displayed on the first UI 122 rendered on a display screen of the electronic device 118. The display screen may be integrated into the electronic device 118 or may be separate from the electronic device 118. The first user 120 may view the displayed booking details on the first UI 122 or the second UI 124. Details of an exemplary first UI that display the booking details are further described, for example, in FIG. 4D.

Although the sequence diagram 200 is illustrated as discrete operations, such as 202, 204, 206, 208, 210, 212, 214 and 216, however, in certain embodiments, such discrete operations may be further divided into additional operations, combined into fewer operations, or eliminated, depending on the particular implementation without detracting from the essence of the disclosed embodiments.

FIGS. 3A and 3B are diagrams that collectively illustrate generation of booking details and render the booking details on a user interface, in accordance with an embodiment of the disclosure. FIGS. 3A and 3B are explained in conjunction with elements from FIGS. 1 and 2. With reference to FIGS. 3A and 3B, there is shown a sequence diagram 300 that illustrates a sequence of operations from 302 to 328. The sequence of operations may be executed by the system 102, the electronic device 118, the MaaS network 106 or the one or more MP servers 112 of FIG. 1.

At 302, the system 102 may select a messaging group that includes a group of members with travel interests same as or similar to that of the first user 120. The system 102 may select the messaging group based on the contextual information and the user data (as described in FIGS. 1 and 2). For example, a search history of the first user 120 on the networking application may suggest an interest of the first user 120 in travelling to the first location (for example, New York). In another example, the one or more messages may indicate the interest of the first user 120 in travelling to the first location (New York). The system 102 may select the messaging group corresponding to the travel interest of the first user 120 to the first location of “New York”.

The messaging group may be a pre-existing group on the networking application with the group of members interested in travelling to certain locations, such as New York. In some embodiments, a plurality of groups with similar travel interest may be present on the networking application. The system 102 may select the messaging group from the plurality of groups, based on the user data and the contextual information. For example, the messaging group may be selected based on an age group of the first user 120, a date of travel preferred by the first user 120, or any other preference of the first user 120.

In one or more embodiments, the selected messaging group may be present on any messaging client, on which the first user 120 may be registered as a user. The system 102 may select the messaging group, based on a user preference for a specific messaging client. In some embodiments, different messaging clients may be associated with the MaaS network 106. The system 102 may select the messaging group from the different messaging clients associated with the MaaS network 106.

At 304, the system 102 may control the electronic device 118 to display a recommendation to join the messaging group. For example, the recommendation to join the messaging group may include a name of the messaging group displayed on the first UI 122. The recommendation to join the messaging group may further include information about the messaging group and the members of the messaging group.

In one or more embodiments, the system 102 may provide recommendation of a plurality of messaging groups, based on the contextual information and the user data. As an example, a first messaging group may be recommended, based on a current location of the first user 120, a second messaging group may be recommended based on the age group of the first user 120, a third messaging group may be recommended based on the interest of the first user 120 to travel with family, friends, or colleagues. Details of an exemplary UI to display the recommendations of the messaging group are further described, for example, in FIG. 4A.

At 306, the system 102 may utilize the one or more NLP models 104 to analyze conversations between the first user 120 and one or more members of the messaging group. For example, the conversations between the first user 120 and one or more members may be analyzed to determine the contextual information. An exemplary conversation may indicate an interest of the first user 120 and the one or more members to travel to the first location (such a location in Europe) around the end of upcoming month. The exemplary conversation may be analyzed by the one or more NLP models 104 to determine the contextual information. For example, the contextual information may include information of the location of interest (such as Europe), preferred dates of the travel (such as September 24 till September 30), and preferred activities of the first user 120 and the one or more members.

At 308, the system 102 may generate the travel plan based on the analysis of conversations between the first user 120 and the one or more members of the messaging group by using the one or more NLP models 104. The travel plan may include the itinerary of the trip for each of the first user 120 and the one or more members undertaking the trip to the first location.

In an embodiment, the preferred activities or a preferred location to visit in Europe may be different for the first user 120 and the one or more members undertaking the trip to Europe. Based on the individual preferences, the system 102 may generate personalized itineraries for the first user 120 and the one or more members. For example, the first user 120 may not be interested to visit a museum. Thus, for the first user 120, the itinerary may exclude a visit to the museum. Instead, the itinerary may include visit to a preferred place (such as a restaurant) nearby to the museum. The system 102 may include the nearby place to the museum as a majority of the one or more members may be at the museum and the first user 120 may be able to join the one or more members at a scheduled time in the trip. Similarly, for each of the one or more members, such exclusions in the itinerary may be made by the system 102.

At 310, the system 102 may control the electronic device 118 to overlay, onto the first UI 122 or the second UI 124, a set of interactive UI elements. The set of interactive UI elements may include a shared schedule associated with the trip. For example, the messaging group may be utilized to initiate or continue conversations between the first user 120 and the one or more members during the trip to the first location. The shared schedule associated with the trip may be overlaid onto the chat UI (such as the first UI 122). The shared schedule may include, for example, the preferred activities, such as meeting up at a restaurant for lunch.

The set of interactive UI elements may further include a poll to determine whether or not to plan an activity in a course of the trip. For example, a poll may be created by the first user 120 to visit an amusement park. The poll may be overlaid on the first UI 122 in the messaging group. The poll may include options, such as an option “Yes” and an option “No”. Each of the one or more members may respond to the poll based on the individual preference, based on which the itinerary may be generated by the system 102.

The set of interactive UI elements may further include news related to one or more locations covered in the trip. For example, a beach location, as part of the itinerary for a trip to the first location may be closed. The news related to the beach may be shared via an interactive UI element in the messaging group.

The set of interactive UI elements may further include items of shared interest associated with the one or more locations. For example, on way to an amusement park, there may be a restaurant. The location and directions to the restaurant may be shared via an interactive UI element in the messaging group.

In accordance with an embodiment, the second UI 124 may include a map UI element onto which the set of interactive UI elements may be overlaid. The map UI element may depict a live route travelled by the first user 120 and the one or more members. For example, the interactive UI element corresponding to the restaurant may be overlaid on an exact location of the restaurant on the live route corresponding to the map UI element. Similarly, the poll to visit the amusement park may be overlaid on the exact location of the amusement park on the map UI element.

At 312, the system 102 may receive a first user input that may correspond to a confirmation of the travel plan, via the first UI 122. For example, the generated travel plan may include the details of the mode of transport, the preferred route, and stoppages on the route (in the travel plan). The system 102 may receive the first user input that may correspond to a confirmation of the travel plan. In some instances, the generated travel plan may not be suitable for the first user 120. For example, the preferred timing of the first user 120 for execution of the travel plan may be different from a time specified in the travel plan. In such a case, the travel plan may not be accepted by the first user 120.

At 314, the system 102 may trigger the MaaS network 106 to generate the booking details based on the received first user input. After reception of the first user input, the MaaS network 106 may be triggered to generate the booking details that may include, for example, reservations for restaurants, visits to the museum, bookings of travel/transportation services (such as cab rides, bus rides, or train rides for one or more legs of a trip), and the like.

In an exemplary scenario, the messaging group may be associated with office of the first user 120. In such a case, the messaging group may include the first user 120 and the group of members (i.e. colleagues of the first user 120). The system 102 may receive a message “I will pick up documents from Justin's place on my way home” from the electronic device 118 associated with the first user 120. Thereafter, the system 102 may process the received message and the user data associated with the first user 120 by using the one or more NLP models 104 to determine the contextual information. The contextual information may include details, such as “location of Justin's place” and “route from the office to Justin's place”. The system 102 may control the electronic device 118 to display the travel plan generated based on the contextual information to the first user 120. In some embodiments, the system 102 may control the electronic device 118 to overlay a set of interactive UI elements (such as the location of Justin's place) on the first UI 122.

In an embodiment, the system 102 may receive, via the first UI 122, a first user input that may correspond to the confirmation of the generated travel plan. Based on the received confirmation, the system 102 may trigger the MaaS network 106 to generate the booking details.

At 316, the system 102 may control the electronic device 118 to display the generated booking details onto the first UI 122 (such as the chat UI) or the second UI 124 (such as the map UI element). The displayed booking details may be viewed by the first user 120 on the first UI 122 or the second UI 124 associated with the networking application. Details of the exemplary first UI that display the booking details are further described, for example, in FIG. 4D.

At 318, the system 102 may receive tracking information associated with events that may occur before and in a course of the trip, from the one or more MP servers 112. For example, the tracking information may include location information associated with the first user 120. The tracking information may include a time of start of the trip (such as the trip to the Justin's place) from the office of the first user 120. The one or more MP servers 112 may keep a record of the tracking information associated with events that may occur before and in the course of the trip.

At 320, the system 102 may detect events. The detection of the events may be based on the booking details and the received tracking information. The events may correspond to a start of each leg of the trip that may be specified in the travel plan. For example, a first leg of the trip may correspond to a travel from office to a colleague's place (such as Justin's place). A second leg of the trip may correspond to travel from Justin's place to home of the first user 120.

The detected event may correspond to start of the first leg of the trip from the office of the first user 120. The events may further correspond to an end of each leg of the trip. For example, the detected event may correspond to end of the first leg of the trip (such as to the Justin's place). The events may further correspond to locations at which each leg of the trip starts and ends. For example, the events may correspond to the start location (such as the office) of the first user 120 and the end location (such as Justin's place). The events may further correspond to timestamps at which each leg of the trip starts and ends. For example, the detected event may correspond to the time of a start of the leg of the trip (such as the trip to the Justin's place) and the time of the end of the leg of the trip. The events may further correspond to a request to change a route or a transportation service provider for at least one leg of the trip. For example, a first route specified in the travel plan for the first leg of the trip may be unsuitable for the first user 120. The system 102 may receive the request to change the first route for the first leg of the trip. The events may further correspond to a change in the route or the transportation service provider. For example, the events may include an alternate route taken by the first user 120 in place of the first route specified in the travel plan.

At 322, the system 102 may track a progress of the trip by executing one or more transactions on distributed ledger nodes (such as nodes of the distributed ledger database 110) of the MaaS network 106, based on the tracked events. For example, the system 102 may execute the one or more transactions by transmission of the tracked events on the distributed ledger nodes of the distributed ledger database 110. In such a manner, the events associated with the first user 120 (that may occur before and in the course of the trip) may be stored securely on the distributed ledger database 110. Based on the executed transactions, the progress of the trip of the first user 120 may be tracked.

At 324, the system 102 may receive a second user input that may correspond to a request to change or cancel a route, a schedule, or a transportation service provider for at least one leg of the trip. The system 102 may receive the second user input via the first UI 122. For example, there may be a change in the travel plan. The first user 120 may want to extend the trip for a few days and may need to visit a second location. The second user input may be received by the system 102 to change the route of a return journey specified in the travel plan. In another example, the second user input may correspond to the change in the transportation service provider for the return journey specified in the travel plan.

At 326, based on the received second user input, the system 102 may trigger the MaaS network 106 to update the booking details. The MaaS network 106 may update the booking details by execution of the transactions on distributed ledger nodes of the MaaS network 106. For example, the updated booking details may include the travel information for the second location. The updated booking details may further include return journey flight information (such as from the second location to a city of residence of the first user 120).

At 328, the system 102 may control the electronic device 118 to render a notification that may inform about the updated booking details. The notification corresponding to the updated booking details may be rendered on the first UI 122.

In an exemplary scenario, the booking details may be for a trip from office to Justin's place for the first user 120. The system 102 may receive the second user input, via the messaging group associated with the home of the first user 120. The messaging group associated with the home of the first user 120 may include the first user 120 and family members of the first user 120. The system 102 may receive the second user input, such as a message “I will be late from work and cannot catch up for dinner” from the electronic device 118 associated with the first user 120. Thereafter, the system 102 may process the received message and the user data associated with the first user 120 by using the one or more NLP models 104 to determine the contextual information. The contextual information may include details, such as “plan dinner on the route to location of Justin's place” or “plan dinner on the route to home from Justin's place”, and “recommendations for restaurants on the route based on user preference”. The system 102 may control the electronic device 118 to display the updated travel plan generated based on the contextual information. In an embodiment, the system 102 may receive the confirmation of the updated travel plan. Based on the received confirmation, the system 102 may trigger the MaaS network 106 to update the booking details.

Although the sequence diagram 300 is illustrated as discrete operations, such as 302, 304, 306, 308, 310, 312, 314, 316, 318, 320, 322, 324, 326 and 328, however, in certain embodiments, such discrete operations may be further divided into additional operations, combined into fewer operations, or eliminated, depending on the particular implementation without detracting from the essence of the disclosed embodiments.

FIG. 4A is a diagram that depicts an exemplary user interface corresponding to a home screen of a networking application, in accordance with an embodiment of the disclosure. FIG. 4A is explained in conjunction with elements from FIGS. 1, 2, 3A and 3B. With reference to FIG. 4A, there is shown a diagram 400A. The diagram 400A may include the electronic device 118. The system 102 may control the electronic device 118 to render a home screen 402. In an embodiment, the home screen 402 may be referred to as the first UI 122 when the networking application is accessed on the electronic device 118. The home screen 402 may include a search bar 404. The search bar 404 may be used to search other users registered on the networking application or different messaging groups associated with different travel locations or other preferences. The networking application may be associated with one or more messaging clients.

The search bar 404 may be used by the first user 120 to search for a preferred location, for example, “New York” for travel. The search bar 404 may be used by the first user 120 to search for a specific user, such as a friend or a colleague. The home screen 402 may display locations travelled by the one or more users (such as the friends of the first user 120). The home screen 402 may also display recommendation to join one or more messaging groups, based on the contextual information and the user data. For example, the recommendation may include a first messaging group “Family Vacay” and a second messaging group “Couple's retreat”.

The home screen 402 may further include a set of icons. The set of icons may include a home icon 406A, a chat icon 406B, a discover icon 406C, an activity icon 406D, and a profile icon 406E. The home icon 406A may be utilized by the first user 120 to view the home screen 402. The chat icon 406B may be utilized by the first user 120 to view the chat UI or to view the messaging group. The discover icon 406C may be utilized by the first user 120 to search for other users. The activity icon 406D may be utilized by the first user 120 to view and track activities of the first user 120 on the networking application. The profile icon 406E may be utilized by the first user 120 to view profile information, such as a username of the first user 120, the registered e-mail of the first user 120, and the contact information of the first user 120.

FIG. 4B is a diagram that depicts an exemplary user interface corresponding to a chat screen of a networking application, in accordance with an embodiment of the disclosure. FIG. 4B is explained in conjunction with elements from FIGS. 1, 2, 3A, 3B and 4A. With reference to FIG. 4B, there is shown a diagram 400B. The diagram 400B may include the electronic device 118.

The system 102 may control the electronic device 118 to render a chat screen 408. The chat screen 408 may be viewed by the first user 120 by pressing the chat icon 406B on the electronic device 118. The chat screen 408 may include a plurality of messaging groups (as icons, for example), of which the first user 120 may be a member. For example, a messaging group “New York trip” is shown. In an example, the messaging group “New York trip” may be created by the first user 120 and the group of members with travel interests same as or similar to that of the first user 120 may be added in the messaging group “New York trip”. The chat screen 408 may display the messaging group “New York trip” and a notification which depicts a number of unread messages in the messaging group “New York trip”.

In an embodiment, a discover screen 410 may be viewed by the first user 120 by pressing the discover icon 406C. The discover screen 410 may be utilized by the first user 120 to search the users by name and to search the messaging groups, by searching the preferred locations through the search bar 404.

FIG. 4C is a diagram that depicts an exemplary chat user interface of a networking application, in accordance with an embodiment of the disclosure. FIG. 4C is explained in conjunction with elements from FIGS. 1, 2, 3A, 3B, 4A and 4B. With reference to FIG. 4C, there is shown a diagram 400C. The diagram 400C may include the electronic device 118. The system 102 may control the electronic device 118 to render a chat UI 412. For example, the chat UI 412 may be viewed by the first user 120 by accessing the messaging group “New York trip”. The chat UI 412 corresponding to the messaging group “New York trip” may include conversations between the first user 120 and the one or more members of the messaging group “New York trip”. The chat UI 412 may further include timestamps of the conversations between the first user 120 and the one or more members.

In some embodiments, the set of interactive UI elements may be overlaid onto the chat UI 412, which may be an exemplary implementation of the first UI 122. An example of an interactive UI element includes a poll to determine whether or not to plan an activity in the course of the trip. For example, the poll to visit the location “Magnolia Bakery” may be overlaid onto the chat UI 412. The chat UI 412 may further include a chat box 414, through which the first UI 122 may input the one or more messages.

FIG. 4D is a diagram that depicts an exemplary user interface that displays booking details, in accordance with an embodiment of the disclosure. FIG. 4D is explained in conjunction with elements from FIGS. 1, 2, 3A, 3B, 4A, 4B and 4C. With reference to FIG. 4D, there is shown a diagram 400D. The diagram 400D may include the electronic device 118. The system 102 may control the electronic device 118 to render a first UI 418 to display the booking details. The booking details may include details, such as the date of start of the trip specified in the travel plan and the details of a group of members travelling with the first user 120 to the first location. The booking details may further include details of various transport services that may be scheduled or booked for certain parts/legs of the trip. Other details, such as the hotel reservation information may be accessible to the first user 120 through a detail icon 420. The first UI 418 may further include a planner icon 422 to access an itinerary of the trip and a map icon 424 to access route of each leg of the trip. The first UI 418 may further include a lists icon 426 to access the lists of activities planned in the trip.

FIG. 4E is a diagram that depicts an exemplary user interface that corresponds to a live map user interface, in accordance with an embodiment of the disclosure. FIG. 4E is explained in conjunction with elements from FIGS. 1, 2, 3A, 3B, 4A, 4B, 4C and 4D. With reference to FIG. 4E, there is shown a diagram 400E. The diagram 400E may include the electronic device 118.

In accordance with an embodiment, the system 102 may receive a set of inputs from the one or more members, including the first user 120 of the messaging group. The set of inputs may be associated with a preference to view or highlight a route 428 undertaken for an active leg of the trip. For example, the route 428 may be the active leg of the trip. Based on an input of the set of inputs, the route 428 may be highlighted. Further, the set of inputs may be associated with the itinerary of the trip that may be undertaken by the one or more members. For example, the system 102 may generate individual itineraries for each of the first user 120 and the one or more members, based on the user preference. The input may be associated with, for example, a landmark included in the itinerary of the trip.

The set of inputs may be further associated with location-specific information associated with the first location and other locations in a course of the trip. For example, an input may be received by the system 102 to view a route to a restaurant. The set of inputs may further be associated with one or more tasks to be performed by the one or more members. For example, a document may need to be picked up by the first user 120. An input may be received by the system 102 to highlight the location of a place from where the document is to be picked up.

The system 102 may generate a live map UI 430 of the trip or the active leg of the trip. Also, the system 102 may generate a plurality of clickable UI elements based on the received set of inputs. For example, a first clickable UI element 432 may correspond to a location of a museum. A second clickable UI element 434 may correspond to a location of a restaurant. A third clickable UI element 436 may correspond to a location of a park. A fourth clickable UI element 438 may correspond to a location of a church. The system 102 may control the electronic device 118 to render a first view of the generated live map UI 430. The first view may include the highlighted route 428. The system 102 may overlay the plurality of clickable UI elements, such as the first clickable UI element 432, the second clickable UI element 434, the third clickable UI element 436 and the fourth clickable UI element 438 at corresponding positions on the first view of the rendered live map UI 430.

In accordance with an embodiment, the system 102 may further receive a selection of a clickable UI element, such as the first clickable UI element 432 of the overlaid plurality of clickable UI elements. The selection of the first clickable UI element 432 may be received via the generated live map UI 430. Based on the received selection, the system 102 may switch the rendered first view to a second view of the live map UI 430. The second view may be different from the first view. For example, the second view may a highlighted route from a current location of the first user 120 to the location of the museum corresponding to the first clickable UI element 432.

In some embodiments, the generated plurality of clickable elements may include one or more augmented reality (AR) elements. For example, the system 102 may determine the electronic device 118 as AR-enabled. Based on the determination, the generated plurality of clickable elements may be presented as one or more AR elements.

FIG. 4F is a diagram that depicts a generated augmented reality (AR) element, in accordance with an embodiment of the disclosure. FIG. 4F is explained in conjunction with elements from FIGS. 1, 2, 3A, 3B, 4A, 4B, 4C, 4D and 4E. With reference to FIG. 4F, there is shown a diagram 400F. The diagram 400F may include the electronic device 118 and an object 440.

The system 102 may determine the electronic device 118 as AR-enabled and may generate a set of interactive AR elements based on the locations already visited in the course of the trip. For example, an AR element of the set of interactive AR elements may correspond to an AR view of an amusement park visited by the first user 120. The set of interactive AR elements may be generated further based on a current location or a future location to be visited in the course of the trip. For example, an AR element of the set of interactive AR elements may correspond to an AR view of a street in which the first user 120 may be present. The generated set of interactive AR elements may be generated further based on the conversations between the first user 120 and the one or more members (i.e. travelers) in the trip. For example, the object 440 may be detected by the first user 120 in the restaurant. The first user 120 may need to converse with the one or more members about the object 440. The object 440 may be scanned by use of an imaging sensor associated with the electronic device 118. The system 102 may generate an AR element 442 corresponding to the object 440.

The system 102 may further generate information 444 about the object 440. For example, the object 440 may be a specific variety of tomato. The generated information 444 about the object 440 may include a name of the object 440 (such as tomato), a generic weight of the object 440, a number of calories that the object 440 has, and a color of the object 440. The generated information 444 may be rendered on the first UI 122 of the electronic device 118.

The set of interactive AR elements may be generated further based on the context of the conversations between the first user 120 and the one or more members. For example, the one or more messages may be associated with a food festival at the first location. The system 102 may generate an AR element corresponding to the food festival at the first location. The set of interactive AR elements may be generated further based on a shared interest (such as a preferred food dish, news items and a specific location) and a shared schedule (such as a departure flight at a same time) of the first user 120 and the one or more members. As an example, an AR element may be based on an avatar of the first user 120. In some embodiments, the set of interactive AR elements may be generated for a specific target group, such as, but not limited to, a group in a specific age bracket or an income bracket, shoppers or followers of a specific brand, or residents of a particular location. The system 102 may control the electronic device 118 to render the generated set of AR elements, such as the AR element 442 corresponding to the object 440 onto the first UI 122 or the second UI 124. The system 102 may allow the users, such as the first user 120 who may have an AR enabled hardware (such as the electronic device 118) to share the AR experience with other members of the one or more members who may not have the AR enabled hardware.

FIG. 4G is a diagram that depicts a plurality of clickable UI elements overlaid on a live map user interface, in accordance with an embodiment of the disclosure. FIG. 4G is explained in conjunction with elements from FIGS. 1, 2, 3A, 3B, 4A, 4B, 4C, 4D, 4E and 4F. With reference to FIG. 4G, there is shown a diagram 400G. The diagram 400G may include the electronic device 118. The electronic device 118 may include the generated live map UI 430 and a plurality of clickable UI elements overlaid on the route 428.

The system 102 may receive a selection of a second clickable UI element 446 of the overlaid plurality of clickable UI elements. The second clickable UI element 446 may correspond to a message from a member of the one or more members and may be overlaid at the location of the member of the one or more members on the route 428.

Based on the received selection of the second clickable UI element 446, the system 102 may overlay a chat window UI onto the live map UI 430. The chat window UI may enable communication between the first user 120 and the member of the one or more members of the messaging group. For example, the second clickable UI element 446 may correspond to a message “Are you ready?” by the member. The second clickable UI element 446 may be clicked by the first user 120, based on which the chat window UI may be overlaid onto the live map UI 430.

In accordance with an embodiment, the system 102 may control, in the course of the trip, the electronic device 118 to render a content consumption UI onto the live map UI 430 of the trip. The content consumption UI may include a media player UI that may display a media content. The media content (such as songs, audiobooks, podcasts, and movies) may be consumed by the first user 120 and the one or more members while travelling. The media content may be categorized as public content or private content, based on a content access type. The public content may be accessible based on the shared interest. The private content (such as message of a head of the department) may be accessible only to specific groups.

The media player UI may display the media content for the first user 120 onto the live map UI 430. The content consumption UI may further include a timeline that may indicate an amount of the media content that may be already consumed or may be yet to be consumed by one or more members, including the first user 120 in the course of the trip. For example, the content consumption UI may include the timeline with timestamps. A progress of the consumption of the media content by each of the first user 120 and the one or more members may be indicated with different timestamps on the timeline. The content consumption UI may further include a viewer UI element that may show the one or more members. For example, the viewer UI element may display names of each of the one or more members.

In accordance with an embodiment, the system 102 may track the consumption of the media content for the one or more members, by execution of the one or more transactions on the distributed ledger nodes of the MaaS network 106. The system 102 may transmit a transaction record corresponding to the consumption of the media content to the distributed ledger nodes (such as the nodes of the distributed ledger database 110) of the MaaS network 106.

The system 102 may enable content providers to track target specific groups and to learn from consumption behavior of the users. The tracking of the specific groups may be utilized to manage content streaming for various groups, such as for teens, adults, kids, and interns.

FIG. 4H is a diagram that depicts an exemplary custom map based user interface, in accordance with an embodiment of the disclosure. FIG. 4H is explained in conjunction with elements from FIGS. 1, 2, 3A, 3B, 4A, 4B, 4C, 4D, 4E, 4F and 4G. With reference to FIG. 4H, there is shown a diagram 400H. The diagram 400H may include a custom map based UI 448.

The custom map based UI 448 may include customized live maps corresponding to each of the first user 120 and the one or more members. For example, a first customized live map 450 may depict a route preferred by the first user 120. A second customized live map 452 may depict a route preferred by a member of the one or more members. For example, the first customized live map 450 may be requested by the first user 120 to view a route map with locations of coffee shops highlighted on the displayed route map.

In one or more embodiments, the custom map based UI 448 may include composite live travel maps associated with a live location of the first user 120 and the one or more members. The custom map based UI 448 may further include composite travel maps of the leg of the route associated with a current leg of the route travelled by the first user 120 and the one or more members. The custom map based UI 448 may further include a live travel map associated with each of the first user 120 and the one or more members.

In an embodiment, the custom map based UI 448 may further include a name and a status (such as an online status or an offline status) of each of the one or more members. For example, the custom map based UI 448 may include a name “Carly Shannon” and may display a last seen status, such as “Connected 2 hours ago” associated with the user “Carly Shannon”.

In an embodiment, the custom map based UI 448 may further include a search bar 454 to search for the members and a search bar 456 to search for the messaging groups. The custom map based UI 448 may further include a timestamp of a current leg of the trip of the travel plan. The custom map based UI 448 may further include a messages window 458 that may include messaging groups which may be common between the first user 120 and the one or more members. The custom map based UI 448 may further include a tasks window 460 that may depict the tasks included in the itinerary.

In an embodiment, the custom map based UI 448 may include a reports window 462 that may include shared documents between the first user 120 and the one or more members. The custom map based UI 448 may further include a tracks window 464 that may include covered routes by the first user 120 and the one or more members, a participants window 466 that may include details of participating members in the trip, an information window 468 that may include miscellaneous information about the events, and an event list window 470 that may include a list of the determined events.

In an embodiment, the custom map based UI 448 may include map layers to display primary content (such as a live route) and interactive customized content for the first user 120. The custom map based UI 448 may further include AR based navigation that may provide location guidance to the first user 120. The system 102 may further generate an AR element corresponding to a locality to explore. The AR element corresponding to the locality may include hidden infrastructure, such as gas pipelines, underground metro, and subways.

The custom map based UI 448 may be utilized to search for nearby areas of the first user 120, based on parameters such as distance, cost, and other metrics. The custom map based UI 448 may be further utilized to share the search results amongst the first user 120 and the one or more members, as a map representation.

FIG. 4I is a diagram that depicts one or more task widgets, in accordance with an embodiment of the disclosure. FIG. 4I is explained in conjunction with elements from FIGS. 1, 2, 3A, 3B, 4A, 4B, 4C, 4D, 4E, 4F, 4G and 4H. With reference to FIG. 4I, there is shown a diagram 400I. The diagram 400I may include the electronic device 118.

The system 102 may control the electronic device 118 to render a first UI 472. Through the first UI 472, the system 102 may receive an input that may correspond to one or more scheduled tasks associated with the first user 120. For example, a first scheduled task may correspond to an inspection of a site “A”. A second scheduled task may correspond to inspection of a site “B”. The system 102 may generate one or more task widgets corresponding to such scheduled tasks. For example, the system 102 may generate a first task widget 474 corresponding to the first scheduled task and a second task widget 476 corresponding to the second scheduled task.

The system 102 may control the electronic device 118 to render the generated one or more task widgets, such as the first task widget 474 and the second task widget 476 along with a live map UI 478 of the trip or the active leg of the trip. In an exemplary scenario, the input that may correspond to the one or more scheduled tasks may include a priority of the one or more scheduled tasks. For example, each of the one or more scheduled tasks may be of a high priority or a low priority. The generated one or more task widgets may include the set priority of the task as well as a date/time by which the one or more scheduled tasks are to be completed.

The system 102 may control the electronic device 118 to render a second UI 480. The first task widget 474 may be accessed by the first user 120 to view the second UI 480 that may include details of the first scheduled task. For example, the second UI 480 may include a date of inspection of a site “A”, a location of site “A”, a description of the first scheduled task, a status of the first scheduled task, notes associated with the first scheduled task, and attached documents associated with the first scheduled task.

FIG. 4J is a diagram that depicts an exemplary visual planner user interface, in accordance with an embodiment of the disclosure. FIG. 4J is explained in conjunction with elements from FIGS. 1, 2, 3A, 3B, 4A, 4B, 4C, 4D, 4E, 4F, 4G, 4H and 4I. With reference to FIG. 4J, there is shown a diagram 400J. The diagram 400J may include a visual planner UI 482.

The system 102 may control the electronic device 118 to render the visual planner UI 482. The visual planner UI 482 may include a first group of UI elements 484 that may graphically represent one or more itinerary items to be covered in the course of the trip. The visual planner UI 482 may further include a second group of UI elements 486, which may correspond to options to configure each of the one or more itinerary items to be covered in the course of the trip. The system 102 may receive a selection of one or more UI elements of the second group of UI elements 486. For example, a UI element 488 may be selected. Based on the received selection, the system 102 may update the travel plan. For example, the UI element 488 may correspond to a visit to a sanctuary. The UI element 488 may be a clickable UI element to mark an itinerary item as complete. The visit to the sanctuary may be removed from upcoming events in the itinerary, based on the selection of the UI element 488. The MaaS network 106 may be triggered to generate the booking details, based on the updated travel plan.

The system 102 may enable a consumption-based billing model for the first user 120 and may provide flexible pricing based on usage patterns of the first UI 122. The system 102 may enable negotiations for inclusions and higher-level access for the messaging group.

Before a trip is planned and in the course of a trip booked through the MaaS network 106, the system 102 may enable a better understanding of the customer (such as the first user 120) for a customized delivery of services. Flexible service delivery models may be utilized by the MaaS network 106 for revenue maximization. With respect to content providers, the flexible combinations of recurrent and consumption pricing allow may allow the content providers to experiment, test in-market, and readjust effectively. The system 102 may allow the content providers to rely on the MaaS network 106 for a seamless access to the services.

It should be noted that the exemplary user interfaces shown in FIGS. 4A-4J are presented merely as examples. Such examples should not be construed as limiting the disclosure. The present disclosure may be applicable to other types of user interfaces.

FIG. 5 is a diagram of an exemplary software-level architecture of the network environment of FIG. 1, in accordance with an embodiment of the disclosure. FIG. 5 is explained in conjunction with elements from FIGS. 1, 2, 3A, 3B, 4A, 4B, 4C, 4D, 4E, 4F, 4G, 4H, 4I, and 4J. With reference to FIG. 5, there is shown a diagram 500. The diagram 500 may represent an exemplary system architecture of the system 102 of FIG. 1.

The diagram 500 may include a natural language processing model 502 and a speech recognition module 504. The speech recognition module 504 may include an acoustic model 506, a language model 508, and a denoising model 510. The diagram 500 may further include a natural language understanding model 512. The natural language understanding model 512 may include a domain classifier 514, a sequence labeler 516, and a state tracker 518.

The diagram 500 may further include a MaaS interface 520 and a map engine 522. The map engine 522 may include an AR module 524, a search module 526, a composer module 528, and a notifications and actions module 530. The diagram 500 may further include a decision making module 532. The decision making module 532 may include a dialogue manager 534 and an intent ranker 536. The diagram 500 may further include a user profile database 538, a context aware recommendation module 540. The context aware recommendation module 540 may include a contextual factors module 542.

The diagram 500 may include a training pipeline 544 and the MaaS network 106. The diagram 500 may further include functional modules 546, which include a high level module 548. The high level module 548 may include an object detection module 550, an image segmentation module 552, and a low resolution handling module 554. The functional modules 546 may further include a low level module 556. The low level module 556 may include a video processing module 558 and an image processing module 560.

The diagram 500 may further include a control module 562. The control module 562 may include an event-based playback control module 564. The diagram 500 may further include an AR web service module 566. The diagram 500 may further include a document database 568, a streaming database 570, a map database 572, and a time-series database 574. The diagram 500 may further include a decentralized user information server 576. The decentralized user information server 576 may include a personal information module 578, a user state module 580, a context module 582, and a virtual reality process data module 584.

The diagram 500 may further include a map engine 586. The map engine 586 may include a map tilt and renderer 588 and a map style generator 590. The diagram 500 may further include a dynamic journey planner 592. The dynamic journey planner 592 may further include a routes integrator 594 and a routes generator 596. The routes generator 596 may further include a scenario based route generator 596A and an optimization based route generator 596B. The dynamic journey planner 592 may further include a routes recommender 598. The routes recommender 598 may further include a context inference and filter module 598A, a route utility calculator 598B and an aggregator 598C. The diagram 500 may further include a recommender system 599.

The user data may be stored in the user profile database 538. The one or more messages, such as the voice-based conversation may be processed by the speech recognition module 504. The speech recognition module 504 may utilize the acoustic model 506, the language model 508, and the denoising model 510 to process the voice-based conversation between the first user 120 and the one or more members.

The context aware recommendation module 540 and the speech recognition module 504 may be utilized by the natural language processing model 502 and the natural language understanding model 512 to determine the contextual information, based on the user data and the one or more messages. The decision making module 532 may further be utilized to analyze the conversations between the first user 120 and the one or more members, to determine the contextual information accurately.

The natural language processing model 502 and the natural language understanding model 512 may provide AI-based intelligence to determine the travel related contextual information from the one or more messages shared between the first user 120 and the one or more members.

The decentralized user information server 576 may be utilized to securely store the user data, such as the personal information of the first user 120. Such decentralized user information server 576 may provide self-sovereignty over the user data. For example, the personal information module 578 may store the personal information of the first user 120 and the user state module 580 may store a status (such as the online status or the offline status) of the first user 120. The user data may be received by the natural language processing model 502 and the natural language understanding model 512 from the decentralized user information server 576, via an interface.

The sharing of the AR based experience between the first user 120 and the one or more members may be facilitated via the AR web service module 566. The control module 562 may be utilized to control the media player UI that may display the media content. The functional modules 546 may be utilized to analyze the natural language input, such as the voice-based conversation, the video-based conversation, or the text-based conversation between the first user 120 and one or more recipients of the one or more messages.

The map engine 522 may be utilized for location and map based services, such as to generate the live map UI and to determine the location of a place. The MaaS interface 520 may be utilized to interface the system 102 for functionalities such as routes, subscriptions, payments, cost, distance, and ride availability. The document database 568 may be utilized to store the documents shared between the first user 120 and the one or more members. The streaming database 570 may be utilized to store the media content streamed in the course of the trip. The map database 572 may be utilized to store the generated map U Is. The time-series database 574 may be utilized to store the timelines associated with the tasks on the trip. The training pipeline 544 may be utilized to train the natural language processing model 502.

The map engine 586 may be utilized to store different representations or variations of the map UI and associated data such as tile sets and styles of the map UI. The routes integrator 594 may be utilized to collect information associated with unimodal routes and aggregate the collected information associated with unimodal routes. The routes integrator 594 may further provide the collected information associated with unimodal routes as an input to the routes generator 596. The routes generator 596 may be utilized to generate optimized route scenarios by use of data (such as data associated with transport, for example, car sharing data, bike sharing data and parking availability) from the mobility players of the MaaS network 106. The routes generator 596 may include a worker thread that may be utilized for map application programming interface (API) for a specific city o a mode of travel. When a planning task may need a group member sharing or parking related information, it may access the database directly. The MaaS API and broker nodes of the routes generator 596 may be used to update the sharing and parking database through a task scheduler and the worker threads.

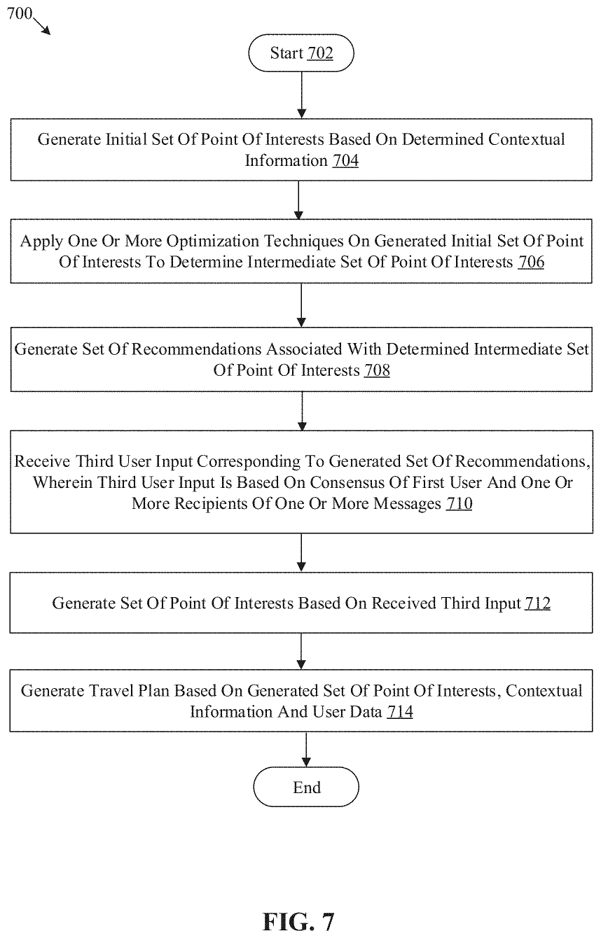

The routes recommender 598 may be utilized to combine the route scenarios, match the combined routes with user or group context, and calculate the utility of a route. The utility of the route may be calculated based on a personal or group utility, an optimal MaaS plan usage utility, environmental friendliness, and a mode promotion utility. The route utility calculator 598B may be utilized to prioritize preferences of the first user or the one or more members by use of weights assigned to parameters associated with the preferences. The routes may be optimized by use of local and global ranking mechanisms. In an exemplary scenario, the preference of the first user may be “well-lit roads”. As the preference “well-lit roads” may not affect the one or more members, the route with well-lit roads may be preferred. In an embodiment, a value of a safety parameter may be increased for certain members in the group (such as a travel group of users) and the group may take in a less optimal route, based on a certain threshold. Different utility-based ranked route list may be aggregated to create a final ranked route list that may be shared with the group. The recommender system 599 may be utilized to generate a set of recommendations associated with a points of interest. Details of the recommender system 599 are further provided, for example, in FIG. 7.

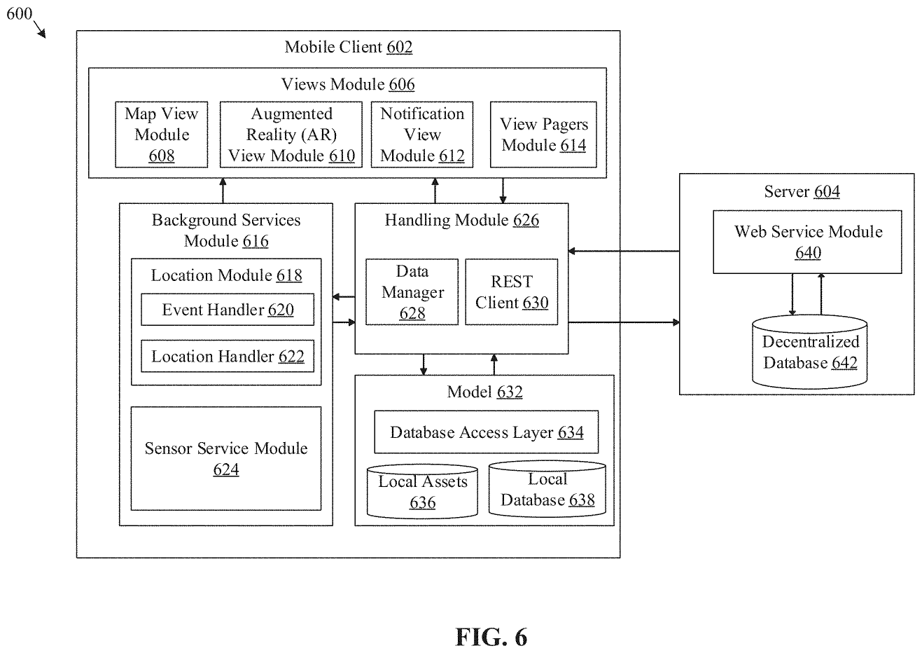

FIG. 6 is an exemplary architecture of an augmented reality (AR)-enabled conversational user experience for a multimodal travel system, in accordance with an embodiment of the disclosure. FIG. 6 is explained in conjunction with elements from FIGS. 1, 2, 3A, 3B, 4A, 4B, 4C, 4D, 4E, 4F, 4G, 4H, 4I, 4J, and 5. With reference to FIG. 6, there is shown a diagram 600. The diagram 600 may include a mobile client 602 and a server 604.

The mobile client 602 may include a views module 606. The views module 606 may include a map view module 608, an AR view module 610, a notification view module 612, and a view pagers module 614. The mobile client 602 may further include a background services module 616. The background services module 616 may include a location module 618. The location module 618 may include an event handler 620 and a location handler 622. The background services module 616 may further include a sensor service module 624.

The mobile client 602 may further include a handling module 626. The handling module 626 may include a data manager 628 and a representational state transfer (REST) client 630. The mobile client 602 may further include a model 632. The model 632 may include a database access layer 634, a local assets database 636, and a local database 638. The server 604 may further include a web service module 640 and a decentralized database 642.

The system 102 may utilize a client-server model to perform the operations associated with the system 102. For example, the mobile client 602 may be a part of the electronic device 118. The server 604 may be a part of the system 102. The mobile client 602 may be communicatively coupled to the server 604 via the communication network 126.

The decentralized database 642 may be utilized to securely store the user data. The mobile client 602 may receive the user data via the server 604 to enable the AR based conversational user experience for the first user 120. The map view module 608 may be utilized to generate the live map UI, onto which the set of interactive AR elements may be overlaid. The AR view module 610 may be utilized to generate the set of interactive AR elements. The notification view module 612 may be utilized to view the notifications, such as the messages between the first user 120 and the one or more members. The view pagers module 614 may be utilized to switch from the first user 120 to the second U 1124.

The location module 618 of the background services module 616 may be utilized to handle the location based services and the determined events at the first location. The sensor service module 624 may be utilized to scan objects so as to generate the set of interactive AR elements.

The REST client 630 of the handling module 626 may be utilized to invoke a REST service application program interface (API) for communication by the system 102 or the transportation service providers. For example, the REST service API may be utilized to determine live traffic information. The database access layer 634 may be utilized to access the user data stored in the local assets database 636 and the local database 638.

FIG. 7 illustrates a flowchart of an exemplary method of generation of a travel plan, based on a set of points of interest, in accordance with an embodiment of the disclosure. FIG. 7 is explained in conjunction with elements from FIGS. 1, 2, 3A-3B, 4A-4J, 5, and 6. With reference to FIG. 7, there is shown a flowchart 700. The exemplary method of the flowchart 700 may be executed by any computing system, for example, by the system 102 of FIG. 1. The exemplary method of the flowchart 700 may start at 702 and proceed to 704.

At 704, an initial set of points of interest may be generated based on the determined contextual information, as described in FIG. 2, for example. In accordance with an embodiment, the system 102 may be configured to generate the initial set of points of interest. In accordance with an embodiment, the acquired one or messages may include names of one or more locations that may be of interest to the first user 120 and the one or more other members of a chat group. The acquired user data may include information about locations preferred by the first user 120 and the members. The contextual information may include the information about such locations.

At 706, one or more optimization techniques may be applied on the generated initial set of points of interest to determine an intermediate set of points of interest. In accordance with an embodiment, the system 102 may be configured to apply the one or more optimization techniques on the generated initial set of points of interest to determine the intermediate set of points of interest. Such techniques may be applied to find a way to combine as many locations as possible along the route of the trip such that a value associated with the trip is maximized for the first user 120.

The application of the one or more optimization techniques may include assignment of a weight to each of the generated initial set of points of interest based on user preferences. The one or more optimization techniques may utilize the initial set of points of interest with high weights to generate the intermediate set of points of interest. Example of the one or more optimization techniques may include, but is not limited to, a travelling salesman problem, an orienteering problem, and a knapsack problem. Examples of the orienteering problem may include a team orienteering problem, an orienteering problem with time windows, a team orienteering problem with time windows, a time-dependent orienteering problem, a multi constrained team orienteering problem with time windows, a generalized orienteering problem, a team orienteering problem with decreasing profits, a clustered orienteering problem, an orienteering problem with stochastic profits, and an orienteering problem with stochastic travel and service times. The knapsack problem may be, for example, an Oregon trail knapsack problem.

At 708, a set of recommendations associated with the intermediate set of points of interest may be generated. In accordance with an embodiment, the system 102 may be configured to generate the set of recommendations associated with the intermediate set of points of interest. The set of recommendations may include the trips and routes on different granularities, such as inner-city routes, road trips, and trips composed of multiple regions. In some embodiments, each item (such as the route or the activities planned on different locations) may be ranked based on the user preferences.

The set of recommendations may include a set of travel items, such as multiple points of interest or travel destinations and a travel plan (referred to as a travel bag or a travel bundle) that may combine coherent travel items, such as destinations, activities, accommodation, and other services in the set of recommendations. The set of recommendations may further include a sequence of items, such as a sequence of the points of interest along an enjoyable route for a single or a multiday trip for the first user 120 and the one or more members travelling with the first user 120.

In one or more embodiments, the set of recommendations may be based on a user' age (included in the user data) or a time of the day of the trip. The travel bundle included in the set of recommendations may be generated before the start of the trip. In an embodiment, the system 102 may utilize travel regions as an input to generate a composite trip, which may be later on included in the set of recommendation. In some instances, the set of recommendations may be generated based on a type of holiday, an office tour, the travel region, and/or an intended means of transportation. The set of recommendations may include buffer slots for itinerary items, such as lunch and dinner in the trip.

In some embodiments, the set of recommendations may exclude high weighted items (i.e. the points of interest) from other lower weighted items to incorporate diversity in the travel plan. The system 102 may analyze prior activity patterns to generate the set of recommendations. The system 102 may analyze the contextual information associated with the first user 120 and the one or more members to generate the set of recommendations.

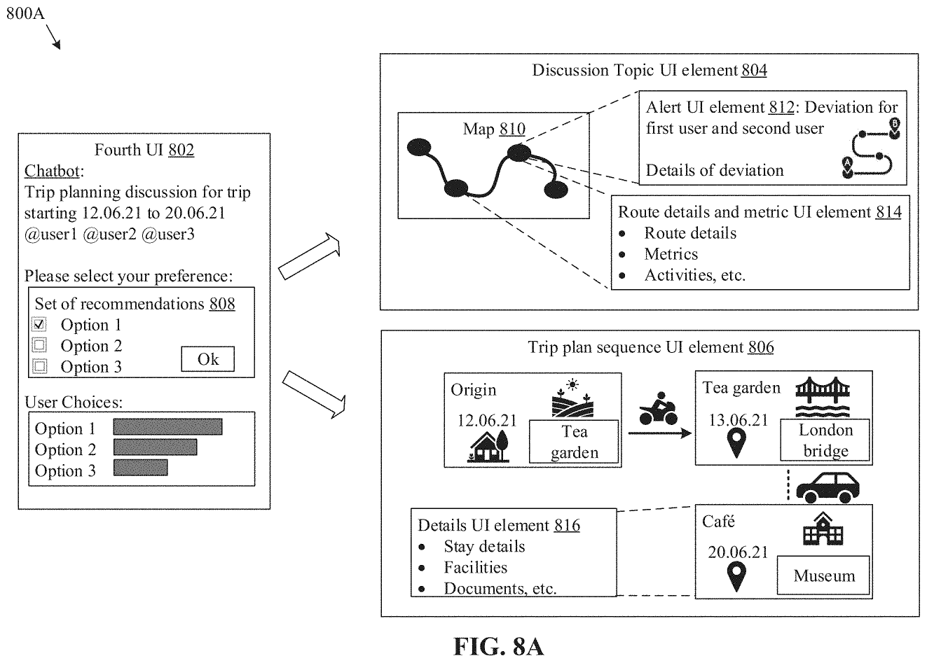

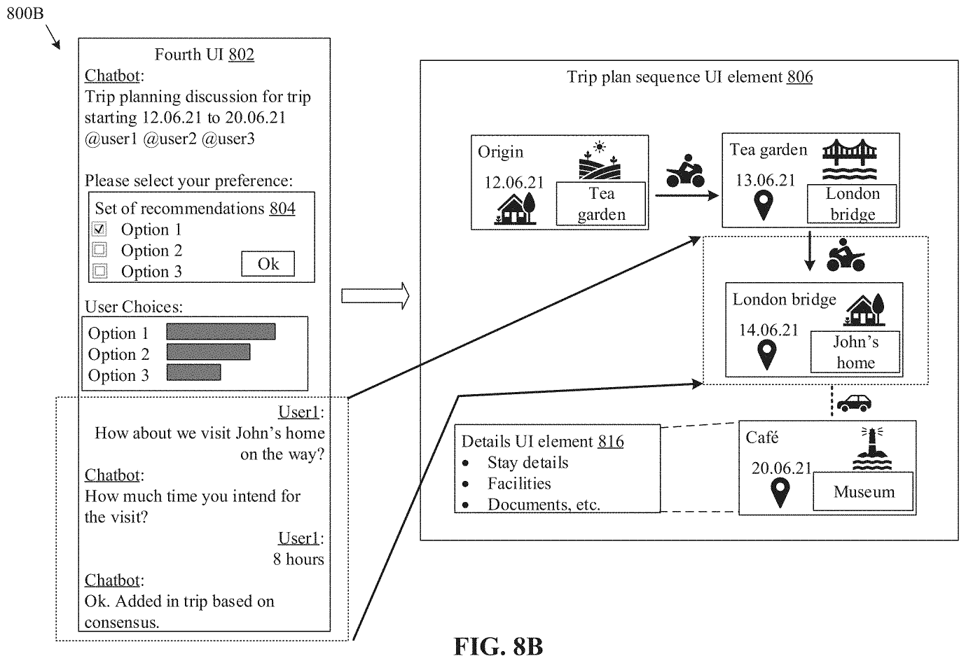

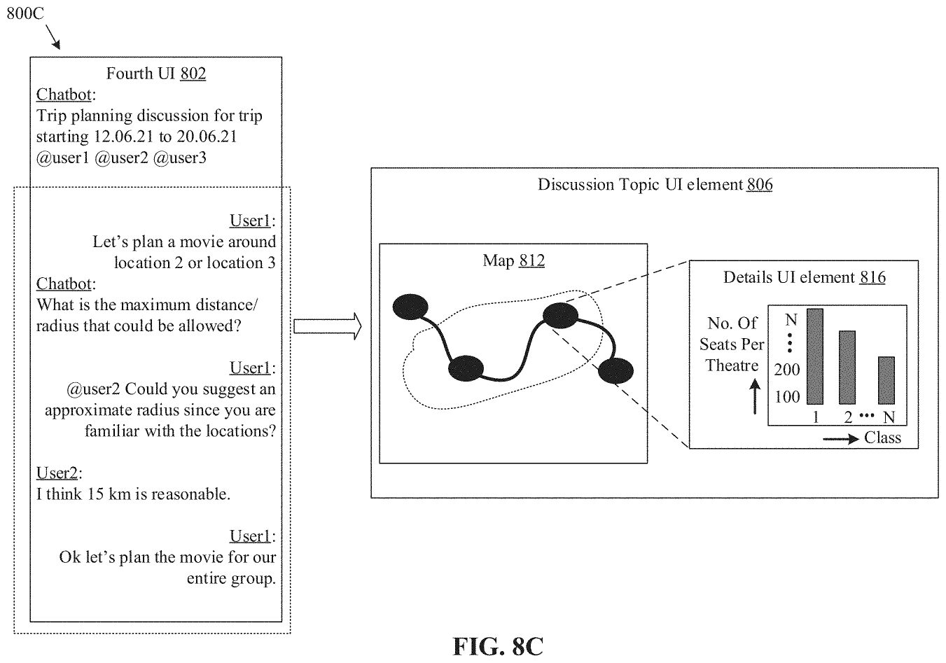

At 710, a third user input corresponding to the generated set of recommendations may be received. The third user input may be based on a consensus of the first user 120 and one or more recipients of the one or more messages. In accordance with an embodiment, the system 102 may be configured to receive the third user input corresponding to the generated set of recommendations. The third user input may be received, for example, via a fourth UI of the plurality of UIs. Details of the reception of the third user input are further described, for example, in FIG. 8A.

At 712, a set of points of interest may be generated based on the received third input. In accordance with an embodiment, the system 102 may be configured to generate the set of points of interest based on the received third input. The generated set of points of interest may include the locations, the activities, the routes, and so forth, based on the consensus of the first user 120 and the one or more members.

At 714, the travel plan may be generated based on the generated set of points of interest, the contextual information, and the user data. The generated travel plan may include the itinerary of the trip for each of the first user 120 and the one or more members undertaking the trip to the first location.

FIGS. 8A-8C are diagrams that collectively illustrate exemplary UI elements, in accordance with an embodiment of the disclosure. FIGS. 8A-8C are explained in conjunction with elements from FIGS. 1, 2, 3A-3B, 4A-4J, 5, 6, and 7.

With reference to FIG. 8A, there is shown a diagram 800A. The diagram 800A may include a fourth UI 802, a discussion topic UI element 804, and a trip plan sequence UI element 806. The fourth UI 802 may display a set of recommendations 808. The discussion topic UI element 804 may include a map 810, an alert UI element 812, and a route details and metric UI element 814. The trip plan sequence UI element 806 may include a details UI element 816.

In an embodiment, the fourth UI 802 may be a chat UI that includes a chatbot to interact with the first user 120 and one or more members who may be a part of a trip to a first location. The system 102 may render the generated set of recommendations 808 in the fourth UI 802. For example, the generated set of recommendations 808 may include multiple options related to an intermediate set of points of interest (described in FIG. 7), the activities, the routes, and the like.

The fourth UI 802 may be utilized by the first user 120 and the one or more members to chat with the chatbot and to update the travel plan. The fourth UI 802 may further be utilized by the first user 120 and the one or more members to provide an input corresponding to the generated set of recommendations 808. The fourth UI 802 may render a poll based on the input received corresponding to the generated set of recommendations 808.

Based on the generated set of points of interest (based on the consensus), the discussion topic UI element 804 may be generated. The discussion topic UI element 804 may be utilized by the first user 120 and the one or members to discuss about the trip. The map 810 may include the map of the current leg and/or past/upcoming leg(s) of the trip. The alert UI element 812 may include details about alerts, such as deviated routes or other alerts associated with the current leg of the trip. The alert UI element 812 may be configured to link items associated with the set of points of interest on the map 810. The route details and metric UI element 814 may include the details of each location on the current leg of the trip, the metrics associated with the route, transport modes and facilities, weather information, and the details of the activities along the current leg of the trip.

Based on the generated set of points of interest, the trip plan sequence UI element 806 may be generated. The trip plan sequence UI element 806 may include a sequence-based list of locations in the current leg of the trip and may be personalized for each individual, such as the first user 120 or the one or more members. In some embodiments, the trip plan sequence UI element 806 may be a map-based sequence UI element which may depict the sequence of locations on the map. The details UI element 816 may include details associated with each location, for example, booking details, hotel details, facilities, and the like. The details UI element 816 may be configured to link items associated with the set of points of interest on the map 810.

Based on the conversations in the fourth UI 802, search and plot locations, and keywords and geocodes may be updated on the map 810. In addition, automated graphic processes (such as legends, custom symbols, and overlays) may be updated. The travel times and routes, buffers, enrich layers with attributes, such as demographic indicators and traffic data (that may be of relevance to the group) may be further updated. Moreover, a specific route may be marked as favorite on the map 810. The map 810 may be saved or a part of the map 810 may be saved as a document or an object for future session modifications. Further, printable map views of the map 810 may be generated. The map view may be shared with other users that may be added later to the discussion topic UI element 804.

With reference to FIG. 8B, there is shown a diagram 800B. The diagram 800B may depict a change in the trip plan sequence, based on the conversation in the fourth UI 802. In an exemplary scenario, the first user 120 may require visiting home of a person during the current leg of the trip. The fourth UI 802 may be utilized by the first user 120 to include a new item, i.e. a visit to the home of the person in the current leg or in an upcoming leg of the trip. The chatbot may confirm the duration of the visit and may receive a consensus from the one or more members to include the location of the home of the person in the current leg or an upcoming leg of the trip. The elements (such as the locations) in the trip plan sequence UI element 806 may be clickable.

With reference to FIG. 8C, there is shown a diagram 800C. The diagram 800C may depict inclusion of details of an activity in the details UI element 816, based on the conversation in the fourth UI 802. In an exemplary scenario, the first user 120 and the one or more members may show an intent to add the activity “watching movie” during the current leg of the trip. The chatbot may ask for information related to the activity “watching movie” in the fourth UI 802. Based on the consensus of the first user 120 and the one or more members, the system 102 may generate a plan to complete the activity “watching movie” in the current leg or an upcoming leg of the trip. For the activity, the suggestions of locations such as movie theatres may be provided through the details UI element 816. The details UI element 816 may be displayed by use of an integration with data service providers of the MaaS network 106.

In some embodiments, the system 102 may generate an activity UI element that may link the set of points of interest to the discussion topic UI element 804, the details UI element 816, and the trip plan sequence UI element 806. The system 102 may further generate a message UI element that may link the set of points of interest to the map 810. In these or other embodiments, the system 102 may generate a hyper card UI element. The hyper card UI element may be linked according to relationship and may be displayed as a new UI element or may be displayed in place of an existing UI element.

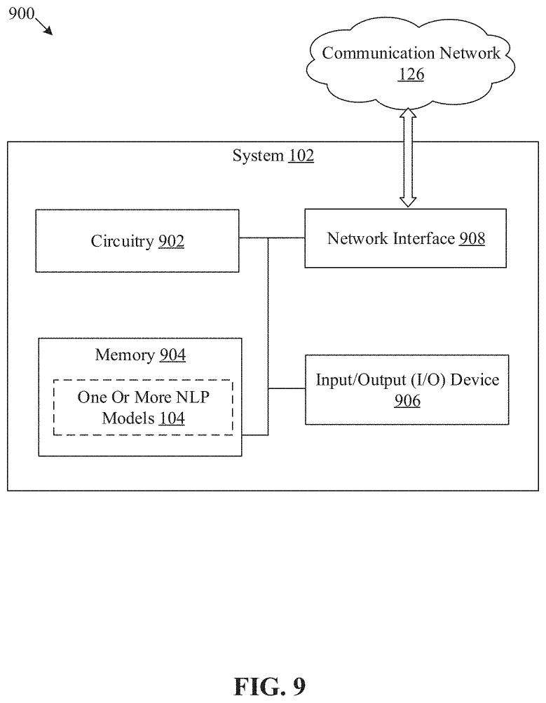

FIG. 9 is a block diagram of an exemplary system for conversational user experience for a multimodal travel system, in accordance with an embodiment of the disclosure. FIG. 9 is explained in conjunction with elements from FIGS. 1, 2, 3A-3B, 4A-4J, 5, 6, 7, and 8A-8C. With reference to FIG. 9, there is shown a block diagram of the system 102. The system 102 may include circuitry 902 and a memory 904. The memory 904 may include the one or more NLP models 104. The system 102 may further include an input/output (I/O) device 906 and a network interface 908.

The circuitry 902 may include suitable logic, circuitry, and interfaces that may be configured to execute program instructions associated with different operations to be executed by the system 102. The circuitry 902 may include one or more processing units, each of which may be implemented as a separate processor. In an embodiment, the one or more processing units may be implemented as an integrated processor or a cluster of processors that perform the functions of the one or more processing units, collectively. The circuitry 902 may be implemented based on a number of processor technologies known in the art. Example implementations of the circuitry 902 may include, but are not limited to, an x86-based processor, x64-based processor, a Graphics Processing Unit (GPU), a Reduced Instruction Set Computing (RISC) processor, an Application-Specific Integrated Circuit (ASIC) processor, a co-processor (such as a Vision Processing Unit (VPU)), a Complex Instruction Set Computing (CISC) processor, a microcontroller, a central processing unit (CPU), and/or a combination thereof.

The memory 904 may include suitable logic, circuitry, and interfaces that may be configured to store the one or more instructions to be executed by the circuitry 902. The memory 904 may be configured to store the one or more messages the user data. The memory 904 may be further configured to store the determined contextual information, the generated travel plan and the generated booking details. Examples of implementation of the memory 904 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 906 may include suitable logic, circuitry, and interfaces that may be configured to receive an input from the first user and the one or more members and provide an output based on the received input. The I/O device 906 which may include various input and output devices, may be configured to communicate with the circuitry 902. Examples of the I/O device 906 may include, but are not limited to, a touch screen, a keyboard, a mouse, a joystick, a microphone, a display device, and a speaker.

The network interface 908 may include suitable logic, circuitry, and interfaces that may be configured to facilitate communication between the system 102, the MaaS network 106, the electronic device 118 the one or more MP servers 112 and the decentralized storage system 116, via the communication network 126. The network interface 908 may be implemented by use of various known technologies to support wired or wireless communication of the electronic device 118 with the communication network 126. The network interface 908 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 908 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

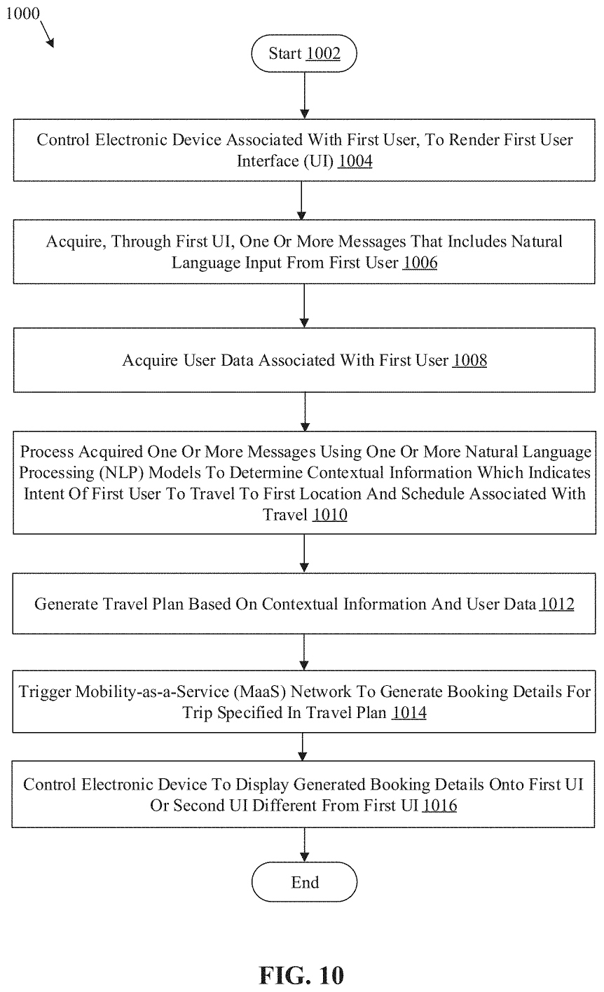

FIG. 10 is a diagram that illustrates an exemplary flowchart of a method for conversational user experience for multimodal travel system, in accordance with an embodiment of the disclosure. FIG. 10 is described in conjunction with elements from FIGS. 1, 2, 3A-3B, 4A-4J, 5, 6, 7, 8A-8C, and 9. With reference to FIG. 10, there is shown a flowchart 1000. The exemplary method of the flowchart 1000 may be executed by any computing system, for example, by the system 102 of FIG. 1. The exemplary method of the flowchart 1000 may start at 1002 and proceed to 1004.

At 1004, the electronic device 118 associated with the first user 120 may be controlled, to render the first UI 122. In accordance with an embodiment, the circuitry 702 may be configured to control the electronic device 118 associated with the first user 120, to render the first UI 122.

At 1006, the one or more messages that may include the natural language input may be acquired from the first user 120, through the first UI 122. In accordance with an embodiment, the circuitry 702 may be configured to acquire the one or more messages that may include the natural language input from the first user 120, through the first UI 122. In some embodiments, the circuitry 902 may be configured to acquire the one or more messages that may include the natural language input from the one or members (such as at least a second user) of the messaging group.

At 1008, the user data associated with the first user 120 may be acquired. In accordance with an embodiment, the circuitry 702 may be configured to acquire the user data associated with the first user 120. In accordance with an embodiment, the circuitry 902 may be configured to acquire the user data associated with the one or members (such as at least the second user) of the messaging group

At 1010, the acquired one or more messages may be processed using the one or more NLP models 104 to determine the contextual information which may indicate the intent of the first user 120 to travel to the first location and the schedule associated with the travel. In accordance with an embodiment, the circuitry 702 may be configured to process the acquired one or more messages using the one or more NLP models 104 to determine the contextual information which may indicate the intent of the first user 120 to travel to the first location and the schedule associated with the travel.

At 1012, the travel plan may be generated based on the contextual information and the user data. In accordance with an embodiment, the circuitry 702 may be configured to generate the travel plan based on the contextual information and the user data. In some embodiments, the circuitry 902 may be configured to generate the travel plan based on the generated set of points of interest (for example, based on the consensus of the first user 120 and the one or more members), the contextual information, and the user data. Details of the generation of the travel plan based on the generated set of points of interest, the contextual information, and the user data, further provided, for example, in FIG. 7.

At 1014, the MaaS network 106 may be triggered to generate the booking details for the trip specified in the travel plan. In accordance with an embodiment, the circuitry 702 may be configured to trigger the MaaS network 106 to generate the booking details for the trip specified in the travel plan.

At 1016, the electronic device 118 may be controlled to display the generated booking details onto the first UI 122 or the second UI 124 different from the first UI 122. In accordance with an embodiment, the circuitry 702 may be configured to control the electronic device 118 to display the generated booking details onto the first UI 122 or the second UI 124 different from the first UI 122.

Although the flowchart 1000 is illustrated as discrete operations, such as 1004, 1006, 1008, 1010, 1012, 1014, and 1016, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions or instructions executable by a machine and/or a computer (for a system, such as the system 102). The system may include circuitry (such as the circuitry 702) communicatively coupled to a Mobility-as-a-Service (MaaS) network (such as the MaaS network 106) associated with a group of transportation service providers. The instructions may cause the machine and/or computer to perform operations that may include control of an electronic device (such as the electronic device 118) associated with a first user (such as the first user 120), to render a first User Interface (such as the first UI 122). The operations may further include acquisition of, through the first UI 122, one or more messages that may include a natural language input from the first user 120. The operations may further include processing of the acquired one or more messages using one or more natural language processing (NLP) models (such as the one or more NLP models 104) to determine contextual information which may indicate an intent of the first user 120 to travel to a first location and a schedule associated with the travel. The operations may further include generation of a travel plan based on the contextual information and the user data. The operations may further include triggering of the MaaS network 106 to generate booking details for a trip specified in the travel plan. The operations may further include control of the electronic device 118 to display the generated booking details onto the first UI 122 or a second UI (such as the second UI 124) different from the first UI 122.

Exemplary aspects of the disclosure may include a system (such as the system 102). The system 102 may include circuitry (such as the circuitry 702) communicatively coupled to a Mobility-as-a-Service (MaaS) network (such as the MaaS network 106) associated with a group of transportation service providers. The circuitry 702 may be configured to control an electronic device (such as the electronic device 118) associated with a first user (such as the first user 120), to render a first User Interface (such as the first UI 122). The circuitry 702 may be further configured to acquire, through the first UI 122, one or more messages that may include a natural language input from the first user 120. The circuitry 702 may be further configured to process the acquired one or more messages using one or more natural language processing (NLP) models (such as the one or more NLP models 104) to determine contextual information which may indicate an intent of the first user 120 to travel to a first location and a schedule associated with the travel. The circuitry 702 may be further configured to generate a travel plan based on the contextual information and the user data. The circuitry 702 may be further configured to trigger the MaaS network 106 to generate booking details for a trip specified in the travel plan. The circuitry 702 may be further configured to control the electronic device 118 to display the generated booking details onto the first UI 122 or a second UI (such as the second UI 124) different from the first UI 122.

In accordance with an embodiment, the first UI 122 may be the chat UI. The natural language input may correspond to one of the voice-based conversation, the video-based conversation, or the text-based conversation between the first user 120 and one or more recipients of the one or more messages.

In accordance with an embodiment, the determined contextual information may further indicate a social context associated with the one or more messages and a social relationship with one or more recipients of the one or more messages.

In accordance with an embodiment, the method may further include storage of the acquired one or more messages and the determined contextual information on the storage node of the decentralized storage system 116. The storage on each node of the decentralized storage system 116 may be specific to the transportation service provider of the group of transportation service providers.

In accordance with an embodiment, the method may further include selection of the messaging group that may include the group of members with travel interests same as that of the first user 120, based on the contextual information and the user data. The method may include control of the electronic device 118 to display the recommendation to join the messaging group. The travel plan may be generated further based on analysis of conversations between the first user 120 and one or more members of the messaging group by using the one or more NLP models 104. The travel plan may include the itinerary of the trip for each of the first user 120 and the one or more members undertaking the trip to the first location.

In accordance with an embodiment, the method may further include control of the electronic device 118 to overlay, onto the first UI 122 or the second UI 124, a set of interactive UI elements. The set of interactive UI elements may correspond to one or more of the shared schedule associated with the trip, the poll to determine whether or not to plan the activity in the course of the trip, the news related to one or more locations covered in the trip, and the items of shared interest associated with the one or more locations.

In accordance with an embodiment, the second UI 124 may include the map UI element onto which the set of interactive UI elements may be overlaid.

In accordance with an embodiment, the method may further include reception, via the first UI 122, of the first user input that may correspond to the confirmation of the travel plan. The MaaS network interface 708 may be triggered to generate the booking details based on the received first user input. The method may further include reception, from one or more transportation service provider servers (such as the one or more MP servers 112), of the tracking information associated with events that may occur before and in the course of the trip. The method may further include detection of the events, based on the booking details and the received tracking information. The events may correspond to the start of each leg of the trip that may be specified in the travel plan, the end of each leg of the trip, the locations at which each leg of the trip may start and end, the timestamps at which each leg of the trip may start and end, the request to change the route or the transportation service provider for at least one leg of the trip, and the change in the route or the transportation service provider. The method may further include tracking of the progress of the trip by executing one or more transactions on distributed ledger nodes of the MaaS network 106 based on the tracked events.

In accordance with an embodiment, the method may further include reception, via the first UI 122, of the second user input that may correspond to the request to change or cancel the route, the schedule, or the transportation service provider for at least one leg of the trip. The method may further include triggering of the MaaS network 106 to update the booking details, based on the received second user input. The MaaS network 106 may update the booking details by executing transactions on distributed ledger nodes of the MaaS network 106. The method may further include control of the electronic device 118 to render the notification that may inform about the updated booking details.

In accordance with an embodiment, the user data may include at least one of the personal information, the set of user preferences, the travel history, the set of content preferences, the content consumption information, the user generated content in the context of locations covered in the trip, and the social data, including the chat history, the set of past interactions with members of one or more messaging groups, the social context of each conversation recorded in the chat history, and the group of people in a social network of the first user 120.

In accordance with an embodiment, the method may further include generation of the initial set of points of interest based on the determined contextual information. The method may further include application of one or more optimization techniques on the generated initial set of points of interest to determine the intermediate set of points of interest. The method may further include generation of the set of recommendations associated with the intermediate set of points of interest. The method may further include reception of the third user input corresponding to the generated set of recommendations. The third user input may be based on the consensus of the first user 120 and one or more recipients of the one or more messages. The method may further include generation of the set of points of interest based on the received third input. The method may further include generation of the travel plan based on the generated set of points of interest, the contextual information, and the user data.

In accordance with an embodiment, the method may further include determination of the electronic device 118 as AR-enabled, and generation of the set of interactive AR elements. The set of interactive AR elements may be generated based on one or more of the locations already visited in the course of the trip, the current location or the future location to be visited in the course of the trip, the conversations between the first user 120 and one or more members in the course of the trip, the context of the conversations, the one or more advertisements and the shared schedule. The method may further include control of the electronic device 118 to render the generated set of AR elements onto the first UI 122 or the second UI 124.

In accordance with an embodiment, the method may further include reception of the set of inputs from one or more members, including the first user 120 of the messaging group. The set of inputs may be associated with at least one of the preference to view or highlight the route undertaken for the active leg of the trip, the itinerary of the trip that is undertaken by the one or more members, the location-specific information associated with the first location and other locations in the course of the trip, and the one or more tasks to be performed by the one or more members. The method may further include generation of the live map UI of the trip or the active leg of the trip. The method may further include generation of the plurality of clickable UI elements based on the received set of inputs. The method may further include control of the electronic device 118 to render the first view of the generated live map UI and overlay the plurality of clickable UI elements at corresponding positions on the first view of the rendered live map UI.

In accordance with an embodiment, the method may further include reception of the selection of the first clickable UI element of the overlaid plurality of clickable UI elements and switching of the rendered first view to the second view of the live map UI based on the received selection. The second view may be different from the first view.

In accordance with an embodiment, the generated plurality of clickable elements may include the one or more AR elements.

In accordance with an embodiment, the method may further include reception of the selection of the second clickable UI element of the overlaid plurality of clickable UI elements and overlaying of the chat window UI onto the live map UI, based on the received selection of the second clickable element. The chat window UI may enable communication between the first user 120 and the member of the messaging group.

In accordance with an embodiment, the method may further include reception of the input that may correspond to one or more scheduled tasks associated with the first user 120. The method may further include generation of the one or more task widgets that may correspond to the one or more scheduled tasks. The method may further include control of the electronic device 118 to render the generated one or more task widgets along with the live map UI of the trip or the active leg of the trip.

In accordance with an embodiment, the method may further include control, in course of the trip, of the electronic device 118 to render the content consumption UI onto the live map UI of the trip. The content consumption UI may include one or more of the media player UI which displays the media content, the timeline indicating the amount of the media content that is already consumed or is yet to be consumed by one or more members, including the first user 120 in the course of the trip, and the viewer UI element which shows the one or more members.

In accordance with an embodiment, the method may further include tracking of the consumption of the media content for the one or more members, by executing one or more transactions on the distributed ledger nodes of the MaaS network 106.

In accordance with an embodiment, the method may further include control of the electronic device 118 to render the visual planner UI, which may include one or more of the first group of UI elements that may graphically represent one or more itinerary items to be covered in the course of the trip, and the second group of UI elements which may correspond to options to configure each of the one or more itinerary items. The method may further include reception of the selection of one or more UI elements of the second group of UI elements. The method may further include update of the travel plan based on the received selection. The MaaS network 106 may be triggered to generate the booking details further based on the updated travel plan.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A method, comprising:
in a system that is communicatively coupled to a Mobility-as-a-Service (MaaS) network associated with a group of transportation service providers:
controlling an electronic device associated with a first user, to render a first User Interface (UI);
acquiring, through the first UI, one or more messages that includes a natural language input from the first user;
acquiring user data associated with the first user;
processing the acquired one or more messages using one or more natural language processing (NLP) models to determine contextual information which indicates an intent of the first user to travel to a first location and a schedule associated with the travel;
generating a travel plan based on the contextual information and the user data;
triggering the MaaS network to generate booking details for a trip specified in the travel plan; and
controlling the electronic device to display the generated booking details onto the first UI or a second UI different from the first UI.

2. The method according to claim 1, wherein the first UI is a chat UI, and
the natural language input corresponds one of a voice-based conversation, a video-based conversation, or a text-based conversation between the first user and one or more recipients of the one or more messages.

3. The method according to claim 1, wherein the determined contextual information further indicates:
a social context associated with the one or more messages, and
a social relationship with one or more recipients of the one or more messages.

4. The method according to claim 1, further comprising storing the acquired one or more messages and the determined contextual information on a storage node of a decentralized storage system,
wherein the storage on each node of the decentralized storage system is specific to a transportation service provider of the group of transportation service providers.

5. The method according to claim 1, further comprising:
selecting, based on the contextual information and the user data, a messaging group that includes a group of members with travel interests same as that of the first user; and
controlling the electronic device to display a recommendation to join the messaging group,
wherein the travel plan is generated further based on analysis of conversations between the first user and one or more members of the messaging group by using the one or more NLP models, and
the travel plan includes an itinerary of the trip for each of the first user and the one or more members undertaking the trip to the first location.

6. The method according to claim 5, further comprising controlling the electronic device to overlay, onto the first UI or the second UI, a set of interactive UI elements corresponding to one or more of:
a shared schedule associated with the trip,
a poll to determine whether or not to plan an activity in a course of the trip,
news related to one or more locations covered in the trip, and
items of shared interest associated with the one or more locations.

7. The method according to claim 6, wherein the second UI includes a map UI element onto which the set of interactive UI elements is overlaid.

8. The method according to claim 1, further comprising:
receiving, via the first UI, a first user input that corresponds to a confirmation of the travel plan, wherein the MaaS network is triggered to generate the booking details based on the received first user input;
receiving, from one or more transportation service provider servers, tracking information associated with events that occur before and in a course of the trip;
detecting, based on the booking details and the received tracking information, the events which correspond to:
a start of each leg of a trip that is specified in the travel plan,
an end of each leg of the trip,
locations at which each leg of the trip starts and ends,
timestamps at which each leg of the trip starts and ends,
a request to change a route or a transportation service provider for at least one leg of the trip, and
a change in the route or the transportation service provider; and
tracking a progress of the trip by executing one or more transactions on distributed ledger nodes of the MaaS network based on the tracked events.

9. The method according to claim 1, further comprising:
receiving, via the first UI, a second user input that corresponds to a request to change or cancel a route, a schedule, or a transportation service provider for at least one leg of the trip;
triggering the MaaS network to update the booking details, based on the received second user input,
wherein the MaaS network updates the booking details by executing transactions on distributed ledger nodes of the MaaS network; and
controlling the electronic device to render a notification that informs about the updated booking details.

10. The method according to claim 1, further comprising:
generating an initial set of points of interest based on the determined contextual information;
applying one or more optimization techniques on the generated initial set of points of interest to determine an intermediate set of points of interest;
generating a set of recommendations associated with the intermediate set of points of interest;
receiving a third user input corresponding to the generated set of recommendations, wherein the third user input is based on a consensus of the first user and one or more recipients of the one or more messages; and
generating a set of points of interest based on the received third input,
wherein the travel plan is generated further based on the generated set of points of interest, the contextual information, and the user data.

11. The method according to claim 1, further comprising:
determining the electronic device as augmented reality (AR)-enabled; and
generating a set of interactive AR elements, based on one or more of:
locations already visited in a course of the trip,
a current location or a future location to be visited in the course of the trip;
conversations between the first user and one or more members in the course of the trip,
a context of the conversations,
one or more advertisements,
a shared interest, and
a shared schedule; and
controlling the electronic device to render the generated set of AR elements onto the first UI or the second UI.

12. The method according to claim 1, further comprising:
receiving a set of inputs from one or more members, including the first user of a messaging group, wherein the set of inputs is associated with at least one of:
a preference to view or highlight a route undertaken for an active leg of the trip;
an itinerary of the trip that is undertaken by the one or more members,
location-specific information associated with the first location and other locations in a course of the trip, and
one or more tasks to be performed by the one or more members;
generating a live map UI of the trip or an active leg of the trip;
generating a plurality of clickable UI elements based on the received set of inputs; and
controlling the electronic device to:
render a first view of the generated live map UI; and
overlay the plurality of clickable UI elements at corresponding positions on the first view of the rendered live map UI.

13. The method according to claim 12, further comprising:
receiving a selection of a first clickable UI element of the overlaid plurality of clickable UI elements; and
switching the rendered first view to a second view of the live map UI based on the received selection, wherein the second view is different from the first view.

14. The method according to claim 12, wherein the generated plurality of clickable elements includes one or more augmented reality (AR) elements.

15. The method according to claim 12, further comprising:
receiving a selection of a second clickable UI element of the overlaid plurality of clickable UI elements; and
overlaying a chat window UI onto the live map UI, based on the received selection of the second clickable element,
wherein the chat window UI enables communication between the first user and a member of the messaging group.

16. The method according to claim 1, further comprising:
receiving an input corresponding to one or more scheduled tasks associated with the first user;
generating one or more task widgets corresponding to the one or more scheduled tasks; and
controlling the electronic device to render the generated one or more task widgets along with a live map UI of the trip or an active leg of the trip.

17. The method according to claim 1, further comprising controlling, in course of the trip, the electronic device to render a content consumption UI onto a live map UI of the trip, wherein the content consumption UI includes one or more of:
a media player UI which displays a media content,
a timeline indicating an amount of the media content that is already consumed or is yet to be consumed by one or more members, including the first user in the course of the trip, and
a viewer UI element which shows the one or more members.

18. The method according to claim 17, further comprising tracking a consumption of the media content for the one or more members, by executing one or more transactions on distributed ledger nodes of the MaaS network.

19. The method according to claim 1, further comprising:
controlling the electronic device to render a visual planner UI, which includes one or more of:
a first group of UI elements that graphically represent one or more itinerary items to be covered in a course of the trip; and
a second group of UI elements which corresponds to options to configure each of the one or more itinerary items;
receiving a selection of one or more UI elements of the second group of UI elements; and
updating the travel plan based on the received selection,
wherein MaaS network is triggered to generate the booking details further based on the updated travel plan.

20. A non-transitory computer-readable medium having stored thereon, computer-executable instructions that when executed by a computer in a system, causes the system to execute operations, the operations comprising:
controlling an electronic device associated with a first user, to render a first User Interface (UI);
acquiring, through the first UI, one or more messages that includes a natural language input from the first user;
acquiring user data associated with the first user;
processing the acquired one or more messages using one or more natural language processing (NLP) models to determine contextual information which indicates an intent of the first user to travel to a first location and a schedule associated with the travel;
generating a travel plan based on the contextual information and the user data;
triggering a mobility-as-a-service (MaaS) network to generate booking details for a trip specified in the travel plan; and
controlling the electronic device to display the generated booking details onto the first UI or a second UI different from the first UI.

21. A system, comprising:
circuitry communicatively coupled to a Mobility-as-a-Service (MaaS) network associated with a group of transportation service providers, wherein the circuitry is configured to:
control an electronic device associated with a first user, to render a first User Interface (UI);
acquire, through the first UI, one or more messages that includes a natural language input from the first user;
acquire user data associated with the first user;
process the acquired one or more messages using one or more natural language processing (NLP) models to determine contextual information which indicates an intent of the first user to travel to a first location and a schedule associated with the travel;
generate a travel plan based on the contextual information and the user data;
trigger the MaaS network to generate booking details for a trip specified in the travel plan; and
control the electronic device to display the generated booking details onto the first UI or a second UI different from the first UI.
